(19) United States
(12) Patent Application Publication
(10) Pub. No.: US 2006/0161472 A1
(43) Pub. Date: Jul. 20, 2006

(54) Method and system for ranking research providers

(76) Inventor: David Weild IV, Bronxville, NY (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/322,718

(22) Filed: Dec. 30, 2005

Related U.S. Application Data
(63) Continuation-in-part of application No. 11/073,980, filed on Mar. 7, 2005.
(63) Continuation-in-part of application No. 11/074,142, filed on Mar. 7, 2005.
(63) Continuation-in-part of application No. 11/074,084, filed on Mar. 7, 2005.
(63) Continuation-in-part of application No. 11/073,809, filed on Mar. 7, 2005.
(63) Continuation-in-part of application No. 11/073,993, filed on Mar. 7, 2005.
(63) Continuation-in-part of application No. 11/073,990, filed on Mar. 7, 2005.
(63) Continuation-in-part of application No. 11/073,994, filed on Mar. 7, 2005.
(63) Continuation-in-part of application No. 11/073,977, filed on Mar. 7, 2005.
(63) Continuation-in-part of application No. 11/135,480, filed on May 23, 2005.
(63) Continuation-in-part of application No. 11/135,579, filed on May 23, 2005.
(63) Continuation-in-part of application No. 11/193,130, filed on Jul. 29, 2005.
(63) Continuation-in-part of application No. 11/192,826, filed on Jul. 29, 2005.
(60) Provisional application No. 60/640,649, filed on Dec. 30, 2004.

(51) Int. Cl. G06Q 99/00; G07G 1/00; G06F 17/30

(52) U.S. Cl. 705/10; 705/1

(57) ABSTRACT

A method of rating a research provider includes determining, for each of a plurality of research providers that provide equity research within a securities sector, one or more research coverage quantifiers. At least one of the research coverage quantifiers is indicative, at least in part, of the specialization of the research provider within the securities sector. Each of the plurality of research providers is ranked based, at least in part, upon at least one of the research coverage quantifiers.

### RELATED APPLICATIONS

This application claims the priority of the following application, which is herein incorporated by reference: U.S. Provisional Application Ser. No. 60/640,649, filed 30 Dec. 2004, entitled, “PAID-FOR RESEARCH SYSTEM AND METHOD”.

This application is a continuation-in-part of the following applications, which are herein incorporated by reference: U.S. Ser. No. 11/073,980, filed: 7 Mar. 2005, entitled: PAID-FOR RESEARCH METHOD AND SYSTEM; U.S. Ser. No. 11/074,142, filed: 7 Mar. 2005, entitled: PAID-FOR RESEARCH METHOD AND SYSTEM; U.S. Ser. No. 11/074,084, filed: 7 Mar. 2005, entitled: DATA STRUCTURE WITH EXPERIENCE DESCRIPTORS; U.S. Ser. No. 11/073,809, filed: 7 Mar. 2005, entitled: DATA STRUCTURE WITH MARKET CAPITALIZATION BREAKDOWN; U.S. Ser. No. 11/073,993, filed: 7 Mar. 2005, entitled: DATA STRUCTURE WITH CODE OF CONDUCT; U.S. Ser. No. 11/073,990, filed: 7 Mar. 2005, entitled: DATA STRUCTURE WITH PERFORMANCE DESCRIPTORS; U.S. Ser. No. 11/073,994, filed: 7 Mar. 2005, entitled: ANALYST SEARCH ENGINE METHOD AND SYSTEM; U.S. Ser. No. 11/073,977, filed: 7 Mar. 2005, entitled: PAID-FOR RESEARCH METHOD AND SYSTEM; U.S. Ser. No. 11/135,480, filed: 23 May 2005, entitled: DISPUTE RESOLUTION METHOD AND SYSTEM; U.S. Ser. No. 11/135,579, filed: 23 May 2005, entitled: PAID-FOR RESEARCH METHOD AND SYSTEM; U.S. Ser. No. 11/193,130, filed: 29 Jul. 2005, entitled: MONITORING METHOD AND SYSTEM; U.S. Ser. No. 11/192,826, filed: 29 Jul. 2005, entitled: PAID-FOR RESEARCH METHOD AND SYSTEM; and U.S. Ser. No. ______, filed: 20 Dec. 2005, entitled: METHOD AND SYSTEM FOR RATING/RANKING THIRD PARTIES.

### TECHNICAL FIELD

This disclosure relates to paid-for business services and, more particularly, to paid-for business research services.

### BACKGROUND

Service providers (e.g., engineers, researchers, academics, contractors, and/or analysts) provide paid-for services for customers (e.g., individuals, corporations, agents and/or sponsors). Examples of the services offered by the service providers include: academic evaluation, research and reporting services; engineering evaluation, research, and reporting services; financial evaluation, research, and reporting services; product evaluation, research, and reporting services; corporate evaluation research, and reporting services; and/or securities evaluation, research, and reporting services.

Real-world examples of the service provider/customer relationships include: the homeowner that hires a contractor to build an addition on the homeowner's house; the construction company that hires an environmental engineering company to prepare an environmental impact study with respect to a highway that is planned for construction; and the company that hires an equity analyst to perform equity research and issue a buy/sell/hold opinion concerning a specific security.

Equity research is a primary tool relied upon by investors and investment professionals to identify, evaluate and filter public companies as candidates for investment. Once invested, equity research may be relied upon to monitor ongoing performance of a company's stock and its potential for future performance.

Equity research is necessary because investors make investment decisions based upon evaluations concerning the future performance potential of a stock. Equity research may also be essential to advancing the media visibility and commercial interests of a company.

As would be expected, a public company does not provide research concerning its own stock, as the research would typically be deemed conflicted and allegations could be made concerning the company's intent to mislead the public. Therefore, since the public relies upon equity research and the companies typically provide comparatively limited guidance, investors must turn to third parties (i.e., the professional research community) for predictions concerning the future performance of a company and it's stock.

Research firms generally have infrastructures that are geared to delivering their research and relevant updates on that research to targeted investors, the media, and corporations. In the case of equity research, these investors, in reaction to an analyst's research, reports, and comments, may issue buy or sell orders for a particular stock, which (on balance) helps promote liquidity in the underlying shares. This increased liquidity often results in greater market efficiency as demonstrated by e.g., tighter trading spreads, lower transaction costs, reduced stock price volatility (risk), and lower cost of capital to the Company, for example.

Academic literature indicates that if a research firm adds equity research coverage on a company, the company tends to add significant market value. Conversely, stocks that have little or no equity research coverage suffer valuation and liquidity discounts, as the stock lacks the visibility and information flow to attract and support a sufficient number of investors, resulting in a lack (on balance) of investor, media and/or commercial interest.

Unfortunately, most public companies no longer generate sufficient trading and commission revenue to naturally attract adequate sell-side equity research coverage, thus resulting in a broad decline in the depth and breadth of “coverage” of public companies. Further, if a public company implicitly contracts for equity research via underwriting engagements with investment banking institutions, the public company and investors risk losing the benefit of the paid-for research, as the integrity, accuracy, and independence of the research may be brought into question.

Additionally, analysts who write or comment in a way that is perceived as contrary (i.e., negative) to the interests of a company may be deprived of necessary access to the company. Specifically, analysts may be blocked from attending or asking questions on conference calls, denied entry to analyst meetings, denied access to management, or turned down on invitations to company management to attend/speak at analyst-sponsored forums, thus depriving the analyst of the ability to do their job.

### SUMMARY OF THE DISCLOSURE

In one implementation, a method of rating a research provider includes determining, for each of a plurality of research providers that provide equity research within a securities sector, one or more research coverage quantifiers. At least one of the research coverage quantifiers is indicative, at least in part, of the specialization of the research provider within the securities sector. Each of the plurality of research providers is ranked based, at least in part, upon at least one of the research coverage quantifiers.

One or more of the following features may also be included. Ranking each of the plurality of research providers may include graphically ranking each of the plurality of research providers based, at least in part, upon at least one of the research coverage quantifiers. The one or more research coverage quantifiers may include a first research coverage quantifier and a second research coverage quantifier. Graphically ranking each of the plurality of research providers may include: rendering a two-dimensional graph that may include a first axis corresponding to the first research coverage quantifier and a second axis corresponding to the second research coverage quantifier.

The one or more research coverage quantifiers may include a third research coverage quantifier. Rendering a two-dimensional graph may include: rendering a bubble chart that may include a first axis corresponding to the first research coverage quantifier, a second axis corresponding to the second research coverage quantifier, and a plurality of graphical indicia indicative of the third research coverage quantifier.

The one or more research coverage quantifiers may include a first research coverage quantifier, a second research coverage quantifier, and a third research coverage quantifier. Graphically ranking each of the plurality of research providers may include: rendering a three-dimensional graph that may include a first axis corresponding to the first research coverage quantifier, a second axis corresponding to the second research coverage quantifier, and a third axis corresponding to the third research coverage quantifier.

Ranking each of the plurality of research providers may include: tabularly ranking each of the plurality of research providers based, at least in part, upon at least one of the research coverage quantifiers. Tabularly ranking each of the plurality of research providers may include: rendering a multi-column table that may include a first column corresponding to at least one of the research coverage quantifiers.

The one or more research coverage quantifiers may include a first research coverage quantifier and a second research coverage quantifier. Tabularly ranking each of the plurality of research providers may include: rendering a multi-column table that may include a first column corresponding to the first research coverage quantifier and a second column corresponding to the second research coverage quantifier.

A user may be allowed to sort the multi-column table based, at least in part, on one of the first and second research coverage quantifiers.

The securities sector may be chosen from the group consisting of: a health care sector; a business sector; a consumer sector; a medical sector; an energy sector; a utilities sector; an insurance sector; a contracting sector; a transportation sector; a pharmaceutical sector; an environmental sector; a technology sector; a telecom sector; a financial sector; an academic sector; an entertainment sector; and a the biotechnology sector. The securities sector may be chosen from the group consisting of: a micro cap securities sector; a small cap securities sector; a mid cap securities sector; and a large cap securities sector.

The one or more research coverage quantifiers may include a commitment quantifier and/or a focus quantifier. A server computer may be configured to perform the above-described method.

In another implementation, a computer program product residing on a computer readable medium has a plurality of instructions stored on it. When executed by the processor, the instructions cause the processor to perform operations including determining, for each of a plurality of research providers that provide equity research within a securities sector, one or more research coverage quantifiers. At least one of the research coverage quantifiers is indicative, at least in part, of the specialization of the research provider within the securities sector. Each of the plurality of research providers is ranked based, at least in part, upon at least one of the research coverage quantifiers.

One or more of the following features may also be included. Ranking each of the plurality of research providers may include graphically ranking each of the plurality of research providers based, at least in part, upon at least one of the research coverage quantifiers. The one or more research coverage quantifiers may include a first research coverage quantifier and a second research coverage quantifier. Graphically ranking each of the plurality of research providers may include: rendering a two-dimensional graph that may include a first axis corresponding to the first research coverage quantifier and a second axis corresponding to the second research coverage quantifier.

The one or more research coverage quantifiers may include a third research coverage quantifier. Rendering a two-dimensional graph may include: rendering a bubble chart that may include a first axis corresponding to the first research coverage quantifier, a second axis corresponding to the second research coverage quantifier, and a plurality of graphical indicia indicative of the third research coverage quantifier.

The one or more research coverage quantifiers may include a first research coverage quantifier, a second research coverage quantifier, and a third research coverage quantifier. Graphically ranking each of the plurality of research providers may include: rendering a three-dimensional graph that may include a first axis corresponding to the first research coverage quantifier, a second axis corresponding to the second research coverage quantifier, and a third axis corresponding to the third research coverage quantifier.

Ranking each of the plurality of research providers may include: tabularly ranking each of the plurality of research providers based, at least in part, upon at least one of the research coverage quantifiers. Tabularly ranking each of the plurality of research providers may include: rendering a multi-column table that may include a first column corresponding to at least one of the research coverage quantifiers.

The one or more research coverage quantifiers may include a first research coverage quantifier and a second research coverage quantifier. Tabularly ranking each of the plurality of research providers may include: rendering a multi-column table that may include a first column corresponding to the first research coverage quantifier and a second column corresponding to the second research coverage quantifier.

A user may be allowed to sort the multi-column table based, at least in part, on one of the first and second research coverage quantifiers.

The securities sector may be chosen from the group consisting of: a health care sector; a business sector; a consumer sector; a medical sector; an energy sector; an insurance sector; a contracting sector; a transportation sector; a pharmaceutical sector; an environmental sector; a technology sector; a telecom sector; a financial sector; an academic sector; an entertainment sector; and a the biotechnology sector. The securities sector may be chosen from the group consisting of: a micro cap securities sector; a small cap securities sector; a mid cap securities sector; and a large cap securities sector.

The one or more research coverage quantifiers may include a commitment quantifier and/or a focus quantifier. A server computer may be configured to perform the above-described method.

The details of one or more implementations is set forth in the accompanying drawings and the description below. Other features and advantages will become apparent from the description, the drawings, and the claims.

### BRIEF DESCRIPTION OF THE DRAWINGS

FIG. 1 is a diagrammatic view of a service management system coupled to a distributed computing network;

FIG. 2 is a more-detailed diagrammatic view of the service management system of FIG. 1;

FIG. 3 is a diagrammatic view of an “individual” data record maintained by the service management system of FIG. 1;

FIG. 4 is a diagrammatic view of a “firm” data record maintained by the service management system of FIG. 1;

FIG. 5 is a flow chart of a process executed by the service management system of FIG. 1;

FIG. 6 is a flow chart of a process executed by the service management system of FIG. 1;

FIG. 7 is a diagrammatic view of a disclosure screen rendered by the service management system of FIG. 1;

FIG. 8 is a diagrammatic view of a search screen rendered by the service management system of FIG. 1;

FIG. 9 is a flow chart of a process executed by the service management system of FIG. 1;

FIG. 10 is a diagrammatic view of an alternative search screen rendered by the service management system of FIG. 1;

FIG. 11 is a diagrammatic view of a result screen rendered by the service management system of FIG. 1;

FIG. 12 is a diagrammatic view of a data record rendered by the service management system of FIG. 1;

FIG. 13 is a flow chart of a process executed by the service management system of FIG. 1;

FIG. 14 is a diagrammatic view of a plurality of third-parties and the offerings being handled by each third-party;

FIG. 15 is a flow chart of a process executed by the service management system of FIG. 1;

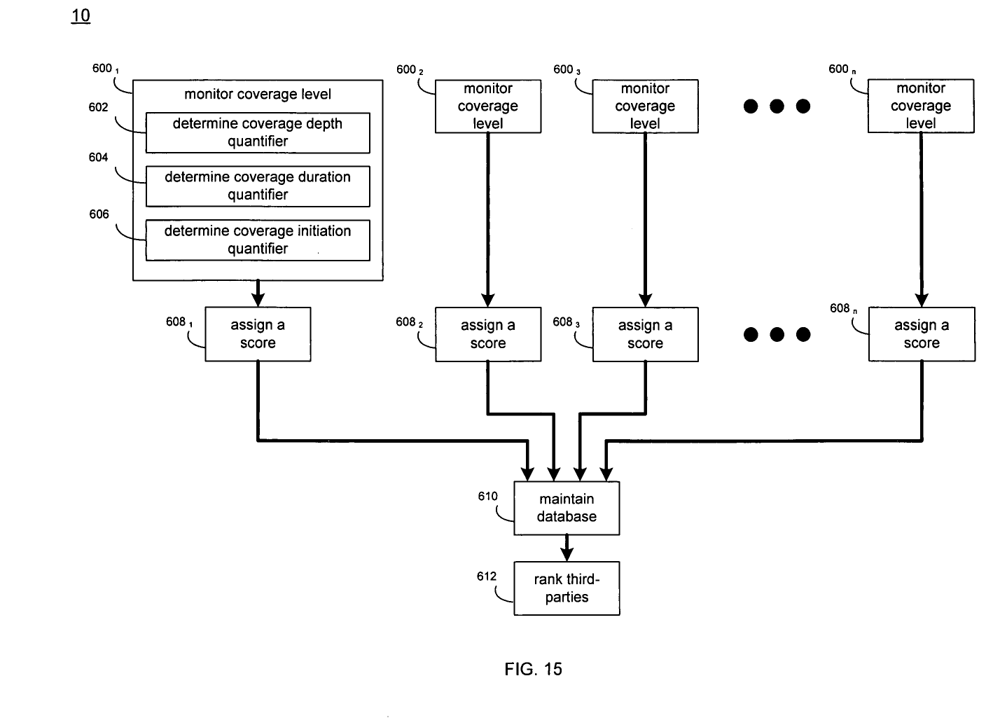

FIG. 16 is a diagrammatic view of a plurality of “third-party” data records maintained by the service management system of FIG. 1;

FIG. 17 is a flow chart of a process executed by the service management system of FIG. 1;

FIG. 18 is a diagrammatic view of a report selection screen rendered by the service management system of FIG. 1;

FIG. 19 is a diagrammatic view of a graph rendered by the service management system of FIG. 1;

FIG. 20 is a diagrammatic view of a table rendered by the service management system of FIG. 1;

FIG. 21 is a diagrammatic view of an alternative report selection screen rendered by the service management system of FIG. 1;

FIG. 22 is a diagrammatic view of a graph rendered by the service management system of FIG. 1; and

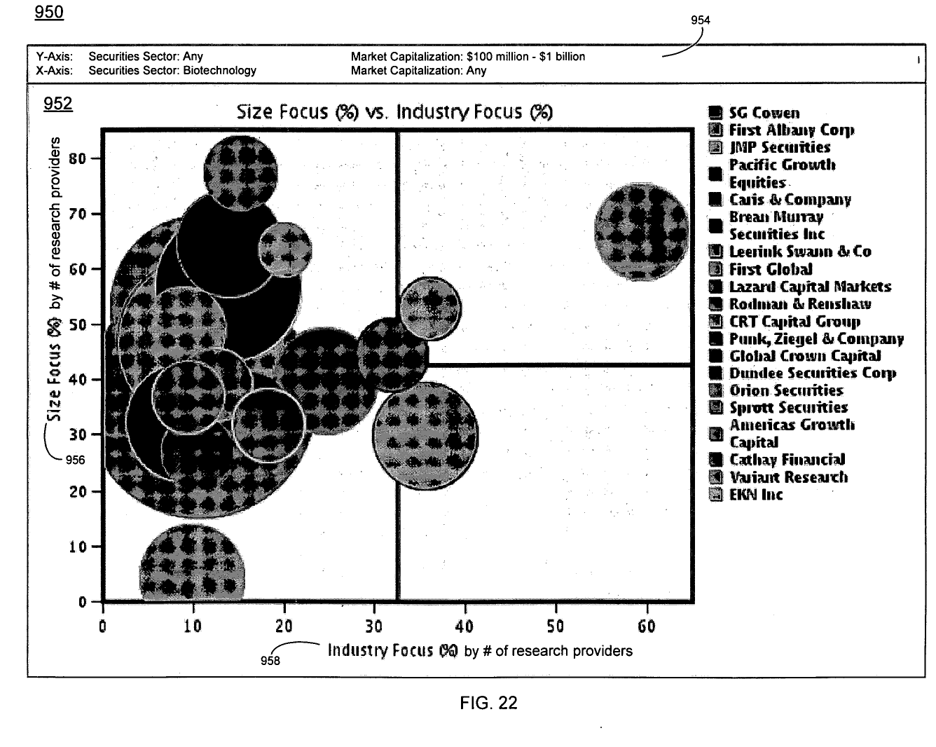

FIG. 23 is a diagrammatic view of a table rendered by the service management system of FIG. 1.

### DETAILED DESCRIPTION OF THE PREFERRED EMBODIMENTS

System Overview:

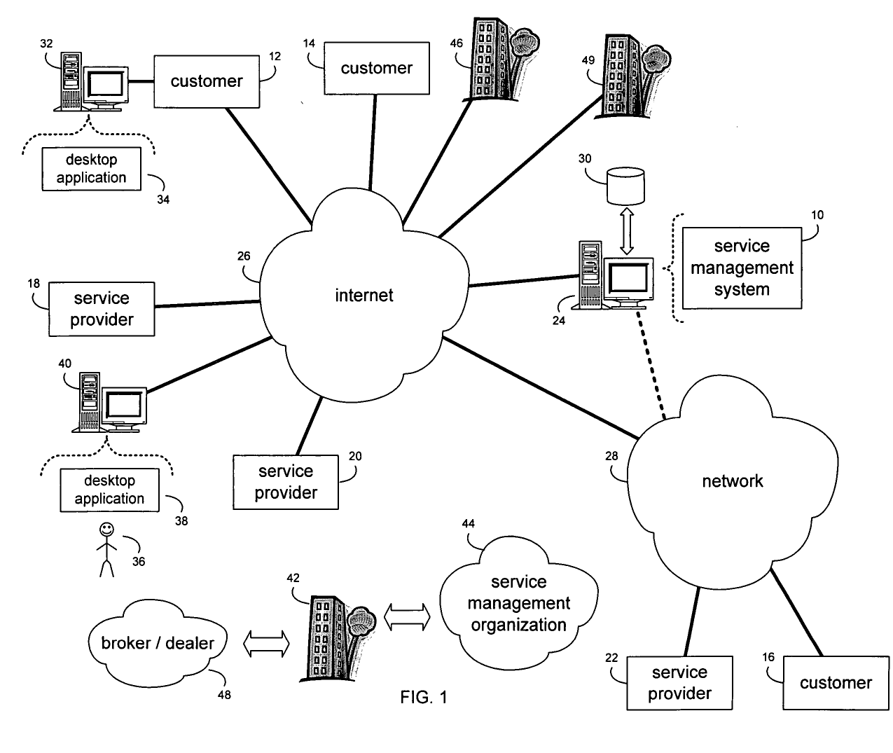

Referring to FIG. 1, there is shown a service management system 10 that allows users (e.g., customers 12, 14, 16) to obtain services within a specific business sector from service providers 18, 20, 22 (e.g., engineers, researchers, academics, contractors, and/or analysts, for example). Customers 12, 14, 16 may be individuals, corporations, agents, investors, institutions, and/or sponsors, for example.

Examples of the specific business sector include: the securities industry; the health care services industry; the business products industry; the business services industry; the consumer products industry; the consumer services industry; the medical products industry; the medical services industry; the energy industry; the insurance industry; the contracting industry; the transportation industry; the pharmaceutical industry; the environmental industry; the technology products industry; the technology services industry; the telecom products industry; the telecom services industry; the financial products industry; the financial services industry; the academic services industry; the entertainment industry; and the business sector(s) of various publically-traded companies, for example.

Examples of the services offered by the service providers include: academic evaluation, research and reporting services; engineering evaluation, research, and reporting services; financial evaluation, research, and reporting services; product evaluation, research, and reporting services; corporate evaluation research, and reporting services; securities evaluation, research, and reporting services; contracting evaluation, research, and reporting services; and/or any other services offered by a company/individual, for example. Additional services (offered by service providers 18, 20, 22) may include: consumer services; business services; health care services; hospital services; rehabilitative services; long-term care services; medical services; energy services; insurance services; contracting services; transportation services; pharmaceutical services; entertainment services; technological services; telecom services; financial services; academic services; and environmental services, for example.

Examples of products that may be evaluated include: consumer products; business products; medical products; energy products; insurance products; contracting products; transportation products; pharmaceutical products; technological products; telecom products; financial products; academic products; entertainment products, and any other product produced by a company/individual.

Service management system 10 typically resides on and is executed by a computer 24 that is connected to network 26 (e.g., the internet). Computer 24 may be a web server running a network operating system, such as Microsoft Window 2000 Server™, Novell Netware™, or Redhat Linux™. Typically, computer 24 also executes a web server application, such as Microsoft IIS™, Novell Webserver™, or Apache Webserver™, that allows for HTTP (i.e., HyperText Transfer Protocol) access to computer 24 via network 26. Network 26 may be connected to one or more secondary networks (e.g., network 28), such as: a local area network; a wide area network; or an intranet, for example.

The instruction sets and subroutines of service management system 10, which are typically stored on a storage device 30 coupled to computer 24, are executed by one or more processors (not shown) and one or more memory architectures (not shown) incorporated into computer 24. Storage device 30 may be, for example, a hard disk drive, a tape drive, an optical drive, a RAID array, a random access memory (RAM), or a read-only memory (ROM).

Customers 12, 14, 16 and service providers 18, 20, 22 may access service management system 10 directly through network 26 or through secondary network (e.g., network 28). Further, computer 24 (i.e., the computer that executes service management system 10) may be connected to network 26 through a secondary network (e.g., network 28).

Customers 12, 14, 16 and service providers 18, 20, 22 typically access service management system 10 through a computer (e.g., computer 32) that is connected to network 26 (or network 28) that executes a desktop application 34 (e.g., Microsoft Internet Explorer™, Netscape Navigator™, or a specialized interface).

An administrator 36 typically accesses and administers service management system 10 through a desktop application 38 (e.g., Microsoft Internet Explorer™, Netscape Navigator™, or a specialized interface) running on an administrative computer 40 that is also connected to the network 26 (or network 28).

The Database:

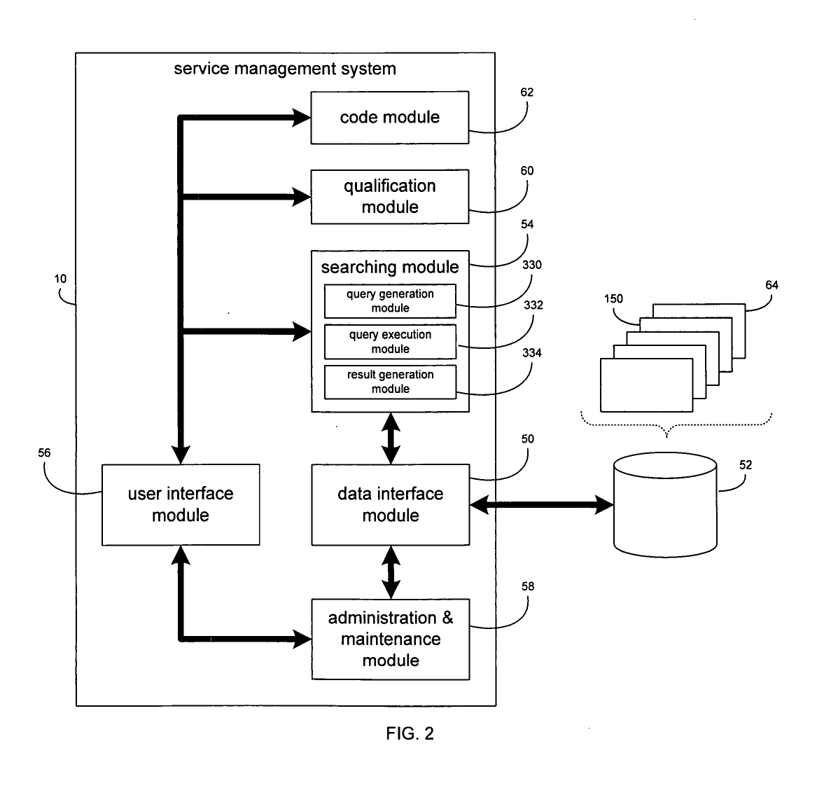

Referring also to FIG. 2, service management system 10 includes: a data interface module 50 for accessing data stored within a database 52 (e.g., an Oracle™ database, an IBM DB2™ database, a Sybase™ database, a Computer Associates™ database or a Microsoft Access™ database); a searching module 54 for searching data records within database 52; a user interface module 56 for allowing customers 12, 14, 16, service providers 18, 20, 22 and administrator 36 to access service management system 10; an administration & maintenance module 58 for allowing administrator 36 to access, configure and maintain service management system 10; a qualification module 60 for qualifying service providers 18, 20, 22 for inclusion within database 52; and a code module 62 for monitoring the actions of customers 12, 14, 16, and service providers 18, 20, 22 to ensure that each adheres to various codes of conduct.

Each of the above-stated modules will be discussed below in greater detail. Further and as will be discussed below in greater detail, in addition to machine-executed processes and procedures performed by one or more of the aforementioned computer systems (e.g., computers 24, 32, 40), one or more of the above-stated modules may include one or more human-executed processes and procedures.

As stated above, service providers 18, 20, 22 offer various services (e.g., academic evaluation, research and reporting services; engineering evaluation, research, and reporting services; financial evaluation, research, and reporting services; product evaluation, research, and reporting services; corporate evaluation research, and reporting services; securities evaluation, research, and reporting services; contracting evaluation, research, and reporting services; and/or any other services offered by a company/individual, for example) to customers 12, 14, 16 that are desirous of obtaining such services.

An example of a typical customer of service management system 10 is an IT (i.e., information technology) product evaluation company that produces quarterly publications that evaluate the newest IT products and technologies. Since the value and reliability of an IT product evaluation company (and the publications produced) are heavily dependent upon the reputation of the IT product evaluation company in the eyes of the consuming public (i.e., the people that make the IT purchasing decisions), it is paramount that the IT product evaluation company be seen as being unbiased, neutral, and knowledgeable in their recommendations. Accordingly, the IT product evaluation company may research and utilize (via service management system 10) engineering researchers and product researchers to generate reports concerning various IT products, such that these reports are incorporated into e.g., the quarterly publications of the IT product evaluation company.

In addition to the information technology area, service management system 10 may be employed in a variety of unrelated areas, such as: the review and evaluation of medical insurance companies, the review and evaluation of long term care facilities; the review and evaluation of securities analysis firms; the generation of environmental impact studies; the issuance of fairness opinions during merger and acquisition proceedings; the appraisal of houses offered for sale; and the review and evaluation of consumer products, for example.

Administration and maintenance module 58 allows administrator 36 to configure and maintain database 52 so that information concerning service providers 18, 20, 22 can be stored in a logical and searchable fashion (via searching module 54). Typically, using administration & maintenance module 58 in combination with data interface module 50, administrator 36 creates one or more data records (e.g., data record 64) that define the service provider and the expertise offered by the service provider.

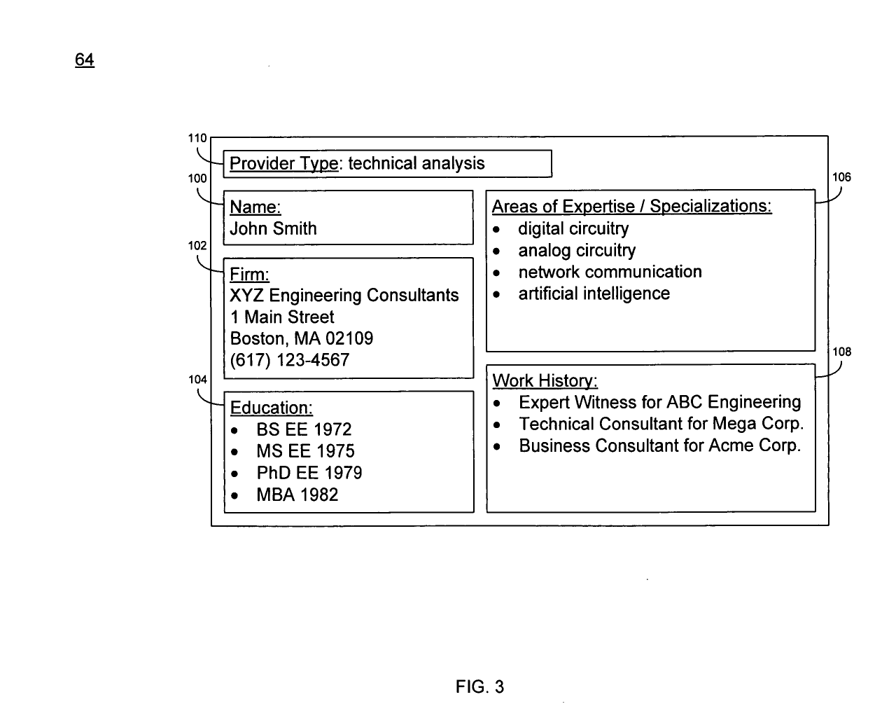

Referring also to FIG. 3, data record 64 may include e.g., a name field 100 for defining the service provider's name, a firm field 102 for defining the firm employing the service provider, an education field 104 for defining the education of the service provider, and an expertise field 106 for defining the areas of expertise/specializations of the service provider. A work history field 108 may define the previous customers for which the service provider has provided services and the type of service provided (assuming the services weren't provided in confidence). The number and type of fields included within a data record (e.g., record 64) may be defined/configured by administrator 36 via user interface module 56 and administration & maintenance module 58.

Depending on the type of service provider, additional fields may be included that provide additional information concerning the service provider. For example, if the service provider is an expert witness in the area of psychology that testifies in criminal cases, an additional field (not shown) may be included that defines the number of times that the expert witness testified for the defense, versus the number of times that the expert witness testified for the prosecution.

As stated above, service providers 18, 20, 22 may be individuals (e.g., engineers, researchers, academics, contractors, or analysts, for example). Additionally, service providers 18, 20, 22 may be firms (e.g., engineering firms or research firms, for example). For example, an individual service provider may be John Smith (an electrical engineer), and a firm service provider may be XYZ Engineering Consultants, a firm that employs over one hundred engineers that cover a broad spectrum of engineering disciplines. Accordingly, if a data record defines a firm (i.e., as opposed to an individual), the areas of expertise/specialization field 106 and the experience field 108 may define the expertise/specializations and experience of the firm as a whole (as opposed to the individuals within the firm).

Since the individual service providers may provide services in a variety of areas (e.g., academic evaluation, research and reporting services; engineering evaluation, research, and reporting services; financial evaluation, research, and reporting services; product evaluation, research, and reporting services; corporate evaluation research, and reporting services; contracting evaluation, research, and reporting services; and/or securities evaluation, research, and reporting services), each data record may include a field that defines the type of service provider.

For example, data record 64 includes a provider type field 110 that defines the “provider type” of John Smith as “technical analysis”. The granularity of the “provider type” descriptor field may be as fine as desired by the administrator (e.g., administrator 36) configuring the data records. For example, for a broad descriptor, John Smith may be classified as “technical analysis”. A narrower descriptor may allow John Smith to define himself as a “technical analysis:electrical”, or even more narrowly as “technical analysis:electrical:digital”.

Depending upon e.g., qualifications and experience, a service provider may be categorized using more than one descriptor. For example, John Smith (having an MBA) may also be qualified to provide business consultation services. Therefore, in addition to using the descriptor “technical analysis”, service provider John Smith may also use the descriptor “business analysis”.

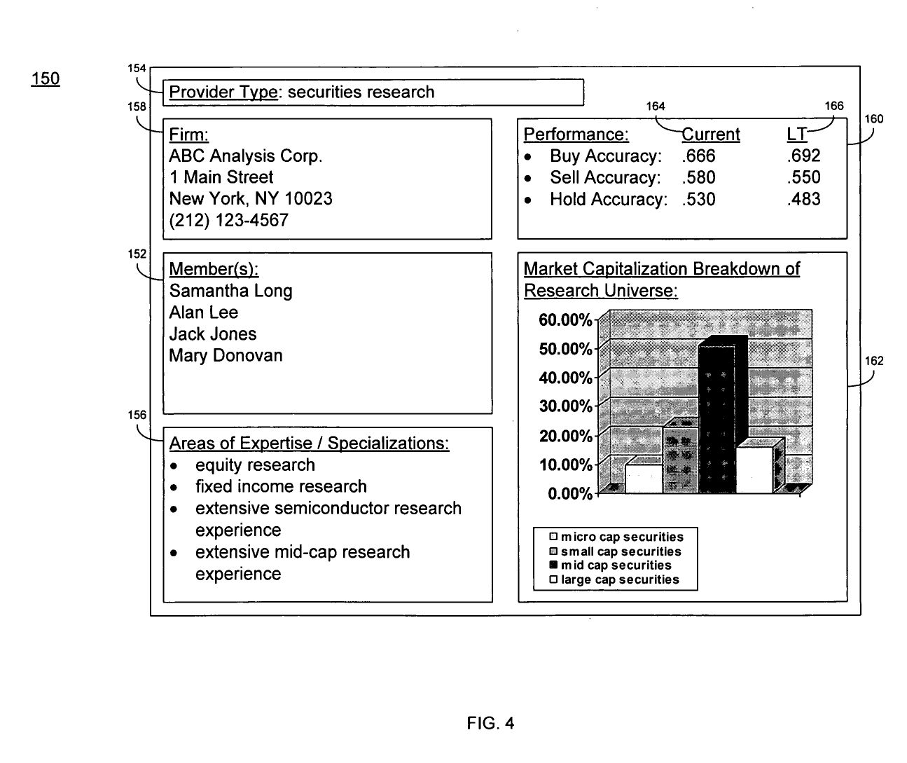

When a data record defines a firm, the record may include a field that defines the individual members of the firm. For example and as shown in FIG. 4, a firm data record 150 (e.g., concerning the ABC Analysis Corp.) may include a member field 152 that defines the members of the firm (e.g., Samantha Long, Alan Lee, Jack Jones, and Mary Donovan). As in data records for “individuals”, data record 150 (i.e., a “firm” data record) includes a provider type data field 154 that defines ABC Analysis Corp. as a service provider that provides “securities research” services concerning e.g., stocks, bonds, derivative securities of stocks, and derivative securities of bonds. Data record 150 may additionally include an area of expertise/specialization field 156 that defines the industry specializations and experience of the firm. For example, concerning securities research firms, the areas of expertise/specializations field 156 may define e.g., experience in the areas of equity research and/or fixed income research. Field 156 may further define: the median size of the company for which the research firm has performed research (e.g., in market capitalization, for example); and the existence of specialized sales forces associated with the research firm. Examples of specialized sales forces may include: salespeople dedicated to stocks of a specific industry (e.g., technology stocks) or a specific geographic origin (e.g., Australian stocks); or salespeople dedicated to a specific type of security (e.g., equities versus convertibles versus corporate debt versus options), for example.

Additionally, field 156 may define: one or more marketing/promotional activities engaged in by the research firm (e.g., arranging institutional investor conferences for management, conference calls with investors, and branch visits, for example); and/or one or more style specializations offered by the research firm (e.g., fundamental versus quantitative versus qualitative, for example). Additional fields within data record 150 include a name field 158 for defining the name of the service provider.

The types of fields included within a data record (and the types of data populating the fields) may vary depending on the “provider type” of the service provider. For example, for data records concerning “securities research” provider types, a performance indicator field 160 may define e.g., an overall ranking/rating/score for the analyst/firm or a ranking/rating/score for specific tasks performed by the analyst/firm. As discussed above, the level of detail and granularity of the data included within a field may be as broad or as narrow as desired. For example, field 160 may provide data concerning the accuracy of the firm's buy/sell/hold security ratings. Continuing with the above-stated example, assume that ABC Analysis Corp. issues quarterly buy/sell/hold ratings for various securities. Accordingly, data field 160 may be populated with numeric descriptors indicating the accuracy of these buy/sell/hold ratings. Assume that at the beginning of a fiscal quarter, ABC Analysis Corp. issues fifty “buy” ratings for fifty (50) different securities. Further, assume that at the end of the same fiscal quarter, seventeen (17) of those fifty (50) securities actually lost value and thirty-three (33) of those fifty (50) securities either maintained or gained value. Accordingly, concerning “Buy Accuracy”, ABC Analysis Corp. would have a rating of 0.666.

What is considered a correct versus an incorrect rating is subjective and may be defined by administrator 36. For example, instead of defining a correct “buy” prediction as simply a security that does not lose money, a correct buy prediction may be defined as one that gains value at a rate greater than or equal to the rate of an index, such as the Standard & Poors 500, or the Consumer Price Index, for example.

For “securities research” provider types, a capitalization field 162 may be included that defines a market capitalization breakdown of the companies covered by the service provider, which defines the relevant experience that the service provider (i.e., the equity research firm) has concerning various market capitalization segments.

The market capitalization of a company is defined as the product of the total number of outstanding shares and the individual share price. Typically, a micro cap security is a share of a company having a market capitalization of less than $100 million; a small cap security is a share of a company having a market capitalization in the range of $100 million to $1 billion; a mid cap security is a share of a company having a market capitalization in the range of $1 billion to $5 billion; and a large cap security is a share of a company having a market capitalization greater than $5 billion.

When a customer is looking for a service provider to do equity research for e.g., a mid cap company, the customer would typically want to employ a service provider that has considerable mid cap equity marketplace proficiency (as opposed to a service provider that exclusively performed equity research for only micro cap and small cap companies). Therefore, when a customer (e.g., customer 16) is reviewing the data records of service providers that the customer is considering contracting with, the market capitalization breakdown 162 in data record 150 (which shows that 51% of the research prepared by ABC Analysis Corp. concerned mid cap securities) is a useful tool that will assist the customer in selecting the appropriate service provider.

As the market capitalization breakdown of an analyst or firm varies over time, the capitalization field 162 should be updated on a regular basis. As will be discussed below in greater detail, when searching database 52, market capitalization breakdown 162 may be used to rank and/or order the analysts/research firms listed within a specific result set.

Various factors may be used to calculate the market capitalization breakdown for a particular analyst/research firm, such as: the number of research pages written; the report generation frequency; and the number of companies within an industry category. The market capitalization breakdown would then be broken down into the various market capitalization categories (e.g., micro cap securities, small cap securities, mid cap securities, and large cap securities).

In addition to the fields included in data record 64 and firm data record 150, additional fields (not shown) may also be defined and included within these data records 64, 150. For example, fields may be included that define: a) the float of one or more securities covered by the service provider; b) the average daily trading volume of one or more securities covered by the service provider; c) a list of the indices in which one or more securities covered by the service provider are included; d) the total number of pages of research generated for one or more securities covered by the service provider; e) the industry grouping of one or more securities covered by the service provider; f) the periodicity of research written concerning one or more securities covered by the service provider; g) the report characteristics of the coverage produced concerning one or more securities covered by the service provider; and/or h) the universe of ratings issued by the service provider (e.g., buy, sell, hold), and the breakdown of each. Each of these fields may be used to rank and/or order the analysts/research firms listed within a specific result set.

Admission Requirements:

Prior to being entered into database 52 (i.e., admitted into the pool of qualified service providers), a service provider must be pre-qualified and deemed to meet or exceed the standards of database 52. The standards of the database are defined by a third-party facilitator 42 and administered and configured by administrator 36, who is typically an employee or agent of third-party facilitator 42. An example of such a third-party facilitator is The National Research Exchange of New York, N.Y. (www.ResearchExchange.com).

Database 52 may be a local database or a remote database maintained by third-party facilitator 42. Additionally or alternatively, database 52 may be maintained by and/or the property of a third party (e.g., an equity research firm).

Once it is determined that a service provider meets or exceeds the standards for admission into database 52, the service provider typically enters into a contract with third-party facilitator 42, is entered into database 52 and becomes a member of a service management organization 44 maintained and administered by third-party facilitator 42.

Additionally and as will be discussed below, customers 12, 14, 16 wishing to obtain paid-for services must also enter into a contract with third-party facilitator 42 and become a member of service management organization 44, prior to being allowed to utilize a service provider (e.g., service providers 18, 20, 22) listed within database 52.

The membership requirement for entry into database 52 (i.e., the pool of qualified services providers) varies depending on the area of expertise in which the service provider provides services. For example, if the service provider is a general contractor that provides construction/improvement services to residential customers, the membership requirement may include: the requirement that the general contractors carry a specified amount of insurance, the requirement that all the individuals employed by the general contractor are covered by disability insurance, and/or the requirement that the general contractor has a specified minimum number of years experience, for example. For general contractors that provide construction/improvement services to commercial customers, there may be additional requirements, such as compliance with certain state or federal standards (e.g., OSHA certifications), and membership in or utilization of certain trades unions.

Additionally, if the service provider is a lawyer, the membership requirements may include: admission into certain bars/jurisdictions; the requirement that the lawyer carry a specified amount of malpractice insurance, the requirement that the lawyer be in good standing in all of the jurisdictions in which they practice, the requirement that the lawyer has never been the subject of disciplinary action; and the requirement that a malpractice claim has never been filed against the lawyer, for example.

Further and expanding on the discussion of performance indicator field 160 of database record 150, if the service provider provides equity research, prior to becoming a member of service management organization 44 and being admitted into database 52 (i.e., the pool of qualified service providers), the service provider may be required to illustrate a defined level of mastery within their area of expertise (i.e., equity research). The mastery level may equate to e.g., a minimum requirement being defined for one or more performance statistics associated with the “buy”, “sell” and “hold” ratings issued by the service provider over a defined period of time. Alternatively, the mastery level may illustrate that the service provider is in compliance with all governmental agencies and SROs (i.e., self-regulatory organizations)

For example, assume service provider 18 (an equity research provider) applies for admission to database 52. Third-party facilitator 42 may examine the “buy”, “sell” and “hold” ratings issued by service provider 18 during e.g., the previous two years (i.e., the two years proceeding the time at which service provider 18 applied for admission to database 52) to determine whether or not the service provider should be admitted to database 52.

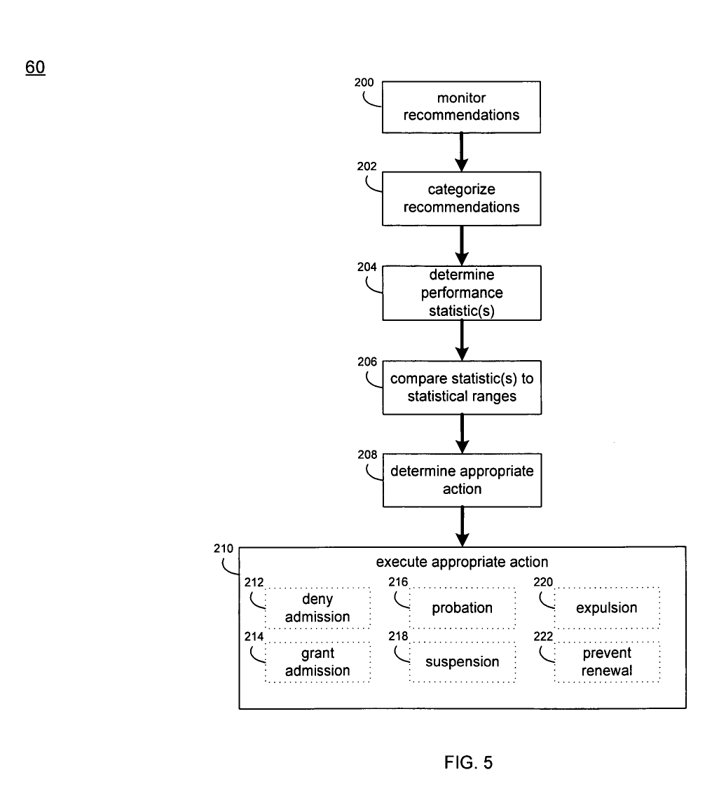

Referring also to FIG. 5, qualification module 60 allows administrator 36 to monitor 200 the total number of recommendations previously made by the service provider. These recommendations are then categorized 202 into correct recommendations and incorrect recommendations and one or more performance statistics are determined 204. As discussed above, this categorization may be dependant upon e.g., the time frame being analyzed and may include e.g., compensation for rates of inflation. The performance statistics are typically numerical ratios (e.g., 0.573) that define the number of correct recommendations versus the total number of recommendations. Once these performance statistics are determined, the accuracy statistic is compared 206 to one or more statistical ranges; a determination 208 is made concerning the appropriate action to be taken; and the action is executed 210.

For example, assume that there are two ranges (e.g., an unacceptable range of 0.000-0.499 and an acceptable range of 0.500-1.000) and the performance statistic for service provider 18 is determined to be 0.473 (i.e., within the unacceptable range). Accordingly, the service provider is denied admission 212 to database 52.

However, the decision to deny admission 212 or grant admission 214 need not be a binary decision, as additional performance ranges may be established. For example, three ranges may be established, namely: an unacceptable range of 0.000-0.399; a probationary range of 0.400-0.499; and an acceptable range of 0.500-1.000. Therefore, if the performance statistic for service provider 18 is determined to be within the unacceptable range, service provider 18 is denied admission 212 to database 52. And if the performance statistic is determined to be within the acceptable range, service provider 18 is granted admission 214 to database 52. However, if the performance statistic for service provider 18 is determined to be within the probationary range, service provider 18 may be granted a probationary admission 216 to database 52. As service provider 18 is admitted on a probationary basis, the service provider may be required e.g., to raise their performance statistic so that it is within the acceptable range within a defined period of time (e.g., one year).

Alternatively, service provider 18 may automatically be granted a probationary admission to database 52. However, at the end of a probationary period (e.g., one year), third party facilitator 42 may either affirm or deny the admission of service provider 18, based upon whether service provider 18 met certain baseline performance benchmarks during the probationary period.

In addition to qualification module 60 determining whether a new service provider should be admitted to database 52, qualification module 60 may also be used to maintain database 52. For example, once admitted to database 52, a service provider (e.g., service provider 18) may be required to maintain an acceptable level of performance or else risk being placed on probation 216, being suspended 218 from database 52, being expelled 220 from database 52, or being prevented 222 from renewing their membership within database 52 (i.e., the pool of qualified analysts).

Continuing with the above-stated example, assume that service provider 18 is granted admission to database 18 and, unfortunately, over the next two years, the performance statistic of service provider 18 drops to 0.383 percent, placing service provider 18 in the unacceptable statistic range. At this point, third-party facilitator 42 may take one of many actions, such as: placing service provider 18 on probation 216 for a defined period of time, during which the service provider must raise their performance statistic to the acceptable level; suspending 218 service provider 18 from database 52 for a defined period of time, during which the service provider (working outside of service management organization 44) must raise their performance statistic to the acceptable level; expel 220 service provider 18 for a defined period of time, after which the service provider may reapply for admission; expel 220 service provider 18 permanently; or prevent 222 service provider 18 from renewing their membership in organization 44.

Accuracy statistic 160 may include more than one statistic. For example and as described above, one of the typical performance statistics for equity research service providers is a statistic that defines their accuracy of the service provider concerning their buy/sell/hold recommendations. In order to provide enhanced information concerning the performance of a particular service provider, a first performance statistic may be defined for buy recommendations, a second performance statistic may be defined for sell recommendations, and a third performance statistic may be defined for hold recommendations. Additionally, the performance statistic may be quantified based on one or more time frames. For example, the performance statistic may include a current performance statistic (i.e., 164, FIG. 4) and a long-term performance statistic (i.e., 166, FIG. 4), similar to the way in which baseball players have both a season batting average and a career batting average. Therefore, for an equity research service provider, a current performance statistic may only concern recommendations made within the last 12 months, while a long-term performance statistic may concern: all of the recommendations made by the service provider since they became a member of organization 44; or all of the recommendations ever made by the service provider.

In addition to third-party facilitator 42 monitoring the “buy”, “sell” and “hold” ratings issued by service provider 18 to determine the performance statistic, other configurations are possible. For example, third-party facilitator 42 may determine the performance statistic by monitoring how often a recommended stock hits a target price within a stated/estimated time period.

These performance statistics (e.g. statistics 164, 166, FIG. 4) are typically recalculated on a periodic basis, such as daily, weekly, monthly, per fiscal quarter, per fiscal year, or per a defined period of time (e.g., a performance statistic that defines the performance level of a service provider during the previous year is recalculated annually).

As stated above, while the above-described examples generally concern service providers that provide equity research, the above-described processes may be generally applied to all service providers, providing there is a manner in which the quality of the service provided by the service provider can be monitored. For example, if the service provider is a residential general contractor, qualification module 60 may monitor the pass/fail ratio of building inspections performed by the building inspector. And, in this scenario, the ranges may be that for all initial inspections performed, the inspection pass rate must be 0.700 and, for reinspections (i.e., the second or greater time a portion of a project is inspected), the pass rate must be 0.950, as the general contractor has already been put on notice concerning the issues that need to be addressed.

Codes of Conduct:

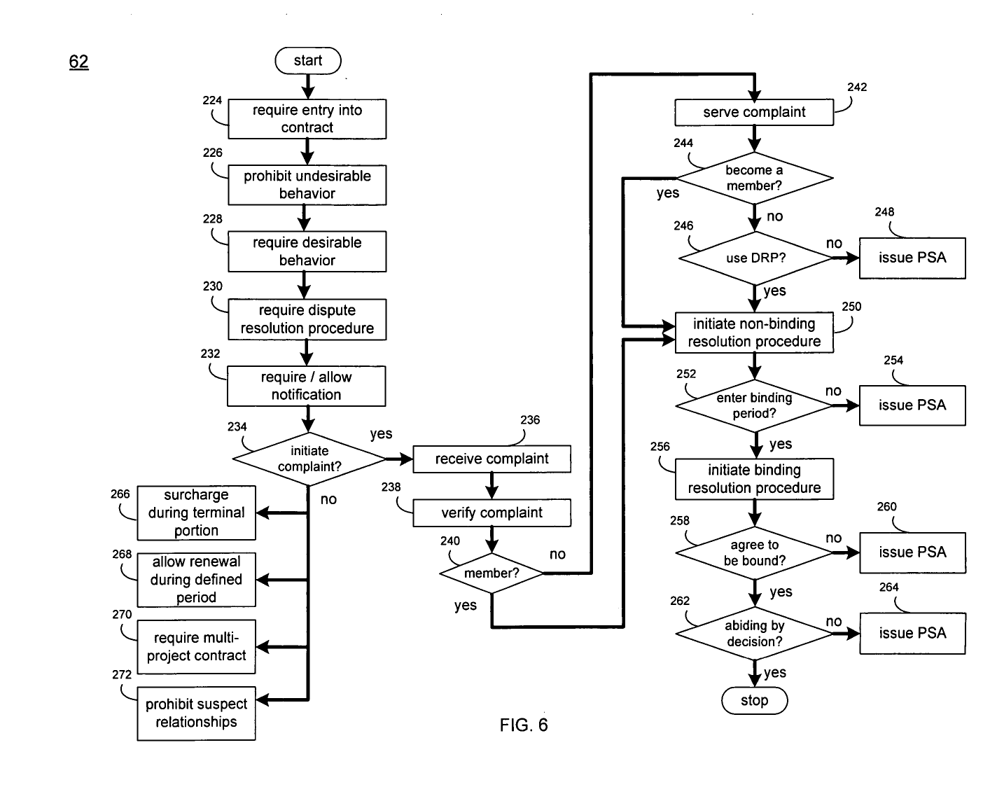

Referring also to FIG. 6, prior to being allowed to join organization 44 (i.e., prior to a service provider 18, 20, 22 being admitted into database 52; and prior to a customer 12, 14,16 being allowed to utilize a service provider within database 52), code module 62 requires 224 all service providers and all customers to contractually agree (i.e., in a membership contract with third-party facilitator 42) to adhere to and be bound by a code of conduct, which regulates the actions and interactions of customers 12, 14, 16, service providers 18, 20, 22, and third-party facilitator 42. Additionally, service provider 18, 20, 22 and/or customer 12, 14, 16 may be required to periodically attest (e.g., on a quarterly or annual basis, for example) to their compliance with the code of conduct.

In the event that a service provider is a firm (as opposed to an individual), the firm may be allowed/required to contractually bind (to the code of conduct) all of the individual members employed by the firm. Therefore, if a firm enters into a contract with third-party facilitator 42 and agrees to be bound by the code of conduct, each of the individual members employed by the firm may be bound by the code of conduct, even though each did not enter into a contract with third-party facilitator 42.

As is known, professional associations and memberships are organized around communities of common professional interest, such as the American Medical Association (i.e., AMA), the American Bar Association (i.e., ABA), the Association for Investment Management and Research (i.e., AIMR), the National Inventor Relations Institute (i.e., NIRI), the New York Stock Exchange (i.e., NYSE) and the National Association of Securities Dealers (i.e., NASD). Many of these professional associations have bylaws of rules of conduct that provide rules and guidelines concerning the level of conduct and professionalism expected from members of these organizations.

The members of organization 44 (i.e., the service providers listed in database 52 and the customers that choose to utilize service providers listed within database 52) interact in a manner similar to that of the members of a professional association, such that the actions and interactions of these members are controlled by the codes of conduct promulgated by third-party facilitator 42.

When defining a code of conduct, consideration is typically given concerning the particular type of service provider and the code of conduct is typically adjusted accordingly. For example, when the service provider is a general contractor, the code of conduct (concerning general contractors) may prohibit any general contractor included in database 52 from performing contracting services on properties owned or operated by building inspectors, especially building inspectors that will be inspecting projects being performed by the general contractor.

Further, when defining a code of conduct, the code is tailored to ensure the integrity of the end product produced. Therefore, the code of conduct (and the enforcement thereof) is designed to prohibit 226 undesirable behavior and require 228 desirable behavior (on the part of the service provider and/or the customer).

For example, if the service provider is an equity analyst, the analysts' code of conduct is tailored such that high-quality, independent and unbiased securities analysis is produced. Therefore, for an equity analyst, prohibited undesirable behavior may include: the user acting in a manner that will knowingly mislead the analyst or the general public; the user retaliating against the analyst; the user disclosing the identity of a known research sponsor; the user inquiring as to the identity of an unknown research sponsor; and the user discriminating against a potential analyst based on previously-generated research, for example.

Additionally, for the equity analyst, the required desirable behavior may include: the user having a reasonable basis for making an allegation concerning a violation of the analyst code of conduct by the analyst; the user taking remedial action to correct known violations of the user code of conduct; and the user disclosing potentially-suspect third-party business relationships (to be discussed below in greater detail), for example.

Further, if the service provider is a general contractor, the contractors' code of conduct may be tailored such that a high-quality construction project is produced using high-quality construction services/techniques; and if the service provider is an engineering research firm, the researchers' code of conduct may be tailored such that high-quality technical research is produced.

Tailoring a code of conduct typically includes: a) identifying membership classes (e.g., contractors, analysts, researchers, and/or customers, for example) that may have significant input and/or influence over the end product produced (e.g., the analysis report, the research report, and/or the project, for example); b) binding these membership classes in a way that incentivizes ethical behavior and disincentivizes unethical behavior; and c) creating disclosures that better protect consumers of the end product.

Typically, when third-party facilitator 42 is defining a code of conduct, a series of diagnostic questions may be asked, such as:
1) What is the end product, service or recommendation?
   a) What is the current “market standard” in serving the end consumer/public?
2) What categories of institutions and individuals hold direct or indirect influence over the end product, service or recommendation?
   a) Is there reason to believe that the interactions between these entities, if properly supervised, would result in a “better than market standard” in serving the end consumer/public?
   b) Can these entities be joined in a reciprocal “code of conduct” and can this conduct be reasonably enforced in a manner that results in a “better than current market standard.”
3) Is there compelling economic interest to cause the intended “membership classes” to join together in a regulated environment such as that organized and monitored by the third-party facilitator?

Continuing with the above-stated example, assume that for equity research service providers, three membership classes are created, namely: a) subject companies and their managers (i.e., the issuer of the security being analyzed); research providers and their analysts (i.e., the company or individual actually performing the equity research); and research sponsors and their managers and/or analysts (i.e., the company/individual/institution sponsoring the equity research), which may include direct sponsors (i.e., entities that fund third-party facilitator 42 to pay for specified research) and/or indirect sponsors (i.e., entities that directly pay research providers with payments that are sufficiently large enough that a “reasonable person” could foresee a conflict of interest).

By regulating the interaction of the membership classes via a code of conduct, third-party facilitator 42 minimizes the potential for inter-party conflicts that, if left unchecked, would likely degrade the integrity of the end product (e.g., the analysis report, the research report, or the project) and, therefore, undermine public interest. Accordingly, through the use of a code of conduct, services rendered under the auspices of third-party facilitator 42 and organization 44 are typically viewed by the general public to be more trustworthy.

Typically, a code of conduct includes multiple governance layers. Continuing with the above-stated example, a typical code of conduct for equity research may include four governance layers, including: A) a reciprocal code of conduct; B) an honor code/infraction-reporting obligation; C) a dispute resolution procedure; and D) one or more disclosure procedures that may include: D1) point of consumption disclosures (incorporated onto the cover of the end product) and D2) web-based disclosures for both members and non-members or the organization; each of which is discussed below in greater detail.

Reciprocal Code of Conduct:

Every member of a membership class within organization 44 has a responsibility not to interfere with the ability of members of other membership classes to fulfill their legal, ethical and professional responsibilities. The reciprocal code of conduct outlines these inter-membership-class responsibilities.

As discussed above, when defining a reciprocal code of conduct, the code is tailored to ensure the integrity of the end product produced. Therefore, if the service provider is an equity analyst, the reciprocal code of conduct is tailored such that high-quality securities analysis is produced, and apportioned with respect to the various membership classes. For example, a typical reciprocal code of conduct for security analysis is as follows:

Concerning Subject Companies:
A) DO NO HARM RULE:
   1) the subject company shall not engage in behavior that will knowingly mislead research providers (i.e., analysts) or the general public;
   2) the subject company shall take corrective action to ensure that misleading statements or behaviors are corrected immediately and in a manner which is in compliance with the law;
   3) the subject company shall not retaliate against other members of the organization (especially research providers) except to pursue due process via the dispute resolution process described below, wherein retaliation includes:
      i) not having a “reasonable basis” for initiating any and all complaints against other members of the organization; and
   4) the subject company may actively discriminate against non-members of the organization, provided such discrimination does not knowingly mislead research providers or the general public.
B) CONFIDENTIALITY RULE:
   1) the subject company shall not disclose the identity of the research sponsor;
   2) the subject company shall not inquire into the identity of the research sponsor;
   3) the subject company shall not disclose fact or detail about their sponsorship activities, if any, except as required by law;
   4) the subject company shall not inquire as to the sponsorship activities of others; and
   5) the subject company shall recognize that analysts must be free of the threat of retaliation of any sort if they are to preserve the integrity of their work product and fulfill their obligation to investors.
C) FAIR TREATMENT RULE:
   1) the subject company shall not discriminate between analysts on the basis of the conclusions and/or recommendations, including such items as:
      i) ratings (buy/sell/hold);
      ii) price targets; and
      iii) estimates (e.g., revenue, earnings, and cash flow, for example);
   2) the subject company shall disclose its policies concerning how it treats analysts and the subject company shall publish these policies in a manner such that they are accessible by other members of the organization;
   3) the subject company shall demonstrate compliance/implementation of the subject company's published policies; and
   4) the subject company shall catalog and record empirical evidence substantiating that the subject company does not discriminate or retaliate against analysts on the basis of their conclusions and/or recommendations, such that the empirical evidence demonstrates:
      i) fair access to senior management for investor visits and conference calls;
      ii) fair access to senior management for sell-side conferences; invitation to and awareness of all analyst events; and
      iii) equal opportunity to ask questions on conference calls with management (e.g., quarterly earnings conference calls and web casts)
   wherein fair access shall be interpreted to mean that the subject company shall provide the same access and support (both quantitatively and qualitatively) to analysts that provide negative opinions as they do to those analysts that provide positive opinions (i.e., those analysts that are perceived to be supportive of the subject company and its management).
D) IMMEDIATE ACTION RULE:
   1) the subject company shall take immediate action to correct any unfair treatment of analysts.
E) FULL DISCLOSURE RULE:
   1) the subject company shall disclose all commercial relationships with research providers including (but not limited to) those concerning:
      i) investment banking;
      ii) commercial banking, including:
         a) lending; and
         b) treasury/cash management;
      iii) money/investment management, including:
         a) firm; and
         b) senior officers;
      iv) any other commercial relationship that may be deemed material to evaluating the independence of research.

Concerning Research Providers:
A) DO NO HARM RULE:
   1) the research provider shall not engage in behavior that will knowingly mislead the public;
   2) the research provider shall take corrective action to ensure that misleading statements/behaviors are corrected immediately and in a manner that is in compliance with the law; and
   3) the research provider shall not retaliate against other members of the organization (especially subject companies) except to pursue due process via the dispute resolution procedures described below, wherein retaliation includes:
      i) engaging in disruptive behavior;
      ii) engaging in manipulative behavior; and/or
      iii) failing to have a “reasonable basis” for initiating any and all complaints against other members of the organization.
B) CONFIDENTIALITY RULE:
   1) the research provider shall not inquire into the identity of a research sponsor;
   2) the research provider shall not ask or speculate as to the identity of the research sponsor; and
   3) wherein strict sponsor confidentiality minimizes the incentive for the research provider to bias their opinion, since the analyst has no way of knowing whether the sponsor has a vested interest in a buy (e.g., public company) or sell (e.g., a competitor company or hedge fund) opinion.
C) REASONABLE BASIS RULE:
   1) the research provider shall distinguish between fact and opinion, and must have a reasonable basis (concerning allegations) supported by:
      i) adequate diligence;
      ii) reasonable care; and
      iii) adequate records to support basis for conclusions.
D) IMMEDIATE ACTION RULE:
   1) the research provider shall take immediate action to correct material mistakes/omissions in research.
E) FULL DISCLOSURE RULE:
   1) the research provider must disclose all conflicts;
   2) all paid-for research must avoid any appearance of impropriety;
   3) the research provider shall not engage in an investment banking business with the subject company until at least six months after the research contract has expired; and
   4) the research provider shall disclose all commercial relationships including (but not limited to) those concerning:
      i) commercial banking, including:
         a) lending; and
         b) treasury/cash management;
      ii) money/investment management, including:
         a) firm; and
         b) senior officers; and
      iii) any other commercial relationship that may be deemed material to evaluating the independence of research.

The research provider may further be required to be in compliances with all federal, state, agency and SRO rules & regulations.

Concerning Research Sponsors:
A) DO NO HARM RULE:
   1) the research sponsor shall not engage in behavior that will knowingly mislead an analyst or the general public;
   2) the research sponsor shall take corrective action to ensure that misleading statements/behaviors are corrected immediately and in a manner that is in compliance with the law;
   3) the research sponsor shall not retaliate against other members of the organization (e.g., subject companies and research providers) except to pursue due process via the dispute resolution procedures described below, wherein retaliation includes:
      i) failing to have a “reasonable basis” for initiating any and all complaints against other members of the organization; and
   4) the research sponsor may actively discriminate (i.e., deny access) against non-members of the organization, as non-members are not bound to the code of conduct and the dispute resolution procedures of the organization.
B) CONFIDENTIALITY RULE:
   1) the research sponsor shall not disclose their identity to anyone other than an employee/agent of the organization unless required by law; and
   2) the research sponsor shall maintain strict confidentiality concerning their research sponsorship activities, and any unnecessary disclosure is presumed to have been with improper intent to influence the research provider(s).
C) FORFEITURE RULE:
   1) in instances where the research sponsor is not the subject company, “specific performance” cures are not available as a remedy, and the available remedies shall be limited to:
      i) censorship;
      ii) suspension of membership; and
      iii) forfeiture of prepaid sponsorship fees
D) FULL DISCLOSURE RULE:
   1) the research sponsor shall keep confidential their research sponsorship activities except in those instances where the research sponsor is a public company, in which case the public company would disclose conflicts only in its capacity as a “subject company”.

While Institutional Investors (i.e., entities such as insurance companies, investment companies, pension funds, and/or trust departments that invest large sums of money in the securities market) typically do not directly contract with analysts (at sell-side providers) for research-related service, Institutional Investors may still assert undue influence upon analysts and research firms. For example, buy-side analysts and portfolio managers may make threats to sell-side analysts concerning e.g., the cutting of commissions and/or the withholding of votes in the various institution investors polls, for example.

As many Institutional Investors will never contract with third-party facilitator 42 for the performance of services (e.g., the generation of research), an Institutional Investor may wish to become a member of organization 44 for the sole purpose of acknowledging that they are willing to be bound by a code of conduct and, therefore, be held accountable for their actions. Accordingly, Institutional Investors are typically governed by rules similar to those of Research Sponsors.

Concerning Institution Investors:
A) DO NO HARM RULE:
   1) the institutional investor shall not engage in behavior that will knowingly mislead an analyst or the general public;
   2) the institutional investor shall take corrective action to ensure that misleading statements/behaviors are corrected immediately and in a manner that is in compliance with the law;
   3) the institutional investor shall not retaliate against other members of the organization (e.g., subject companies, research providers, and research sponsors) except to pursue due process via the dispute resolution procedures described below, wherein retaliation includes:
      i) failing to have a “reasonable basis” for initiating any and all complaints against other members of the organization; and
   4) the institutional investor may actively discriminate (i.e., deny access) against non-members of the organization, as non-members are not bound to the code of conduct and the dispute resolution procedures of the organization.
B) CONFIDENTIALITY RULE:
   1) the institutional investor shall maintain strict confidentiality concerning their research sponsorship activities, and any unnecessary disclosure is presumed to have been with improper intent to influence the research provider(s).
C) FORFEITURE RULE:
   1) since “specific performance” cures are not available as a remedy, the available remedies shall be limited to:
      i) censorship;
      ii) suspension of membership; and
      iii) forfeiture of prepaid sponsorship fees
         Honor Code:

As will be discussed below, code module 62 requires 230 that each member of organization 44 contractually agree to utilize a dispute resolution procedure to settle allegations concerning violations of the code of conduct. Further, every member of a membership class (i.e., both customers and service providers of organization 44) is required 232 to report (to third-party facilitator 42) any and all observed infractions of the reciprocal code of conduct caused by another member of organization 44 or by a non-member of organization 44.

When allegations are made by a member of organization 44 concerning an alleged infraction of the conduct code by either: another member of organization 44; or a non-member of organization 44, the accusing member may initiate 234 a complaint (which is filed with and received 236 by third-party facilitator 42) that outlines the conduct (engaged in the accused member/non-member) that is alleged to violate the code of conduct. Typically, these complaints are electronically submitted by organization members via code module 62 and a secure website (to be discussed below), in which the organization member making the allegation and the member/non-member that is the target of the allegation are identified, and the specifics of the alleged event are outlined. Alternatively, the complaint may be filed in writing with third-party facilitator 42.

Once the complaint is received 236 by third party facilitator 42 (via e.g., code module 62), the complaint is typically reviewed and the technical sufficiency of the complaint is verified 238 (e.g., verifying that the accused member/non-member is identified, verifying that the accusing member is identified, and verifying that the conduct taken by the accused member/non-member may indeed violate the code of conduct, for example) by code module 62.

As stated above, allegations of conduct code infractions may concern the actions of both members and/or non-members of organization 44. Once the complaint is verified 238, if the allegations concern 240 an alleged conduct code violation by a non-member, third party facilitator 42 serves 242 a copy of the complaint on the accused non-member. This service 242 of complaint is typically similar to that used in civil proceedings (e.g., a process server delivers a copy of the complaint to the accused non-member).

Once served 242, the accused non-member may be offered 244 the opportunity to become a member of service management organization 44 maintained and administered by third-party facilitator 42. If the accused non-member agrees to become a member of service management organization 44, the dispute resolution procedure (described below in greater detail) is initiated to investigate and resolve the dispute.

If the accused non-member refuses to join organization 44, the accused non-member may be offered 246 the opportunity to participate in the dispute resolution procedure (described below in greater detail) so that the substance of the complaint can be investigated and resolved. With the exception of out-of-pocket costs (e.g., lawyers fees and witness fees, for example), the accused non-member may typically participate in the dispute resolution procedure at no cost.

If the accused non-member refuses to participate in the dispute resolution procedure, third party facilitator 42 may issue 248 a public service announcement that publicly discloses: the allegation made against the accused non-member; and the fact that the accused non-member was given the opportunity but refused to participate in the dispute resolution procedure. Typically, this public service announcement is made via e.g., a web site maintained by the third-party facilitator 42, a press release, a trade publication/journal, and/or a general or industry-specific newspaper/magazine, for example.

Conversely, if the accused non-member agrees to participate in the dispute resolution procedure, the dispute resolution procedure (described below in greater detail) is initiated to investigate and resolve the dispute.

As with the reciprocal code of conduct, the honor code is tailored (based on business sector) to ensure the integrity of the end product produced. Therefore, if the service provider is an equity analyst, the analysts' honor code is tailored such that high-quality securities analysis and research is produced, and apportioned with respect to the various membership classes. For example, a typical honor code for security analysis is as follows:

Concerning Subject Companies:
A) the subject company shall report to the organization:
   1) renegade analysts (both members and non-members) that make analyst statements and conclusions for which there is no factual basis and which (if left unchecked) will do harm to current or future investors; and
B) the subject company shall:
   1) document and maintain a history of all requests that an analyst has made of the subject company management and how the subject company management responded to those requests;
   2) document all invitations that the subject company management has extended to analyst;
   3) be available to serve as an arbitrator; and
   4) maintain current user profiles on all subject company management that interfaces with analysts and/or investors.

Concerning Research Providers:
A) the research provider shall report to the organization:
   1) instances in which the research provider believes they were treated in a way (by either members or non-members) that interferes with the research provider's ability to do their job, provided this treatment is a violation of the honor code and not simply the byproduct of the subject company management managing their time and/or other resources; and
B) the research provider shall:
   1) document and maintain a history of all requests that the research provider has made of the subject company management and how the subject company management has responded to those requests;
   2) document all invitations that the subject company management has extended to the research provider;
   3) be available to serve as an arbitrator;
   4) maintain current and accurate all information that is stored in the database concerning the research provider; and
   5) provide the organization with access to all research ratings, reports and other coverage information (both current & historical), such that the organization (or an agent of the organization) may evaluate the performance of the research provider.

Concerning Research Sponsors and “Deemed” Sponsors (i.e., buy-side account members that pay commissions to research provider firms):
A) the research sponsor shall report to the organization:
   1) renegade analysts (both members and non-members) that make analyst statements and conclusions for which there is no factual basis and which (if left unchecked) will do harm to current or future investors; and
   2) violations of the terms of any contract entered into by the organization for specified research, such that the organization may withhold payment pending an investigation.
      Dispute Resolution Procedure:

In order to deliver services that have a high level of integrity, any allegations that jeopardize the integrity of the end product provided by the service provider should be disclosed and adjudicated swiftly to curtail damage to the offended member (e.g., the service provider and/or the customer) and the general public that relies on the integrity of the end product.

In order to facilitate swift adjudication of disputes, a two-part dispute resolution procedure is employed, which includes: a mandatory non-binding resolution period; and a mandatory binding resolution period.

When an complaint is initiated 234 and verified 238 by third-party facilitator 42 (via e.g., a secure website or in writing), a mandatory non-binding resolution period (e.g., fourteen days) is typically initiated 250 (by code module 62) to assist the parties involved in privately and confidentially settling the dispute amongst themselves (prior to having the dispute elevated to a higher level).

In the event that such a settlement cannot be achieved during the above-described non-binding resolution period, the two parties must agree 252 to enter into the mandatory binding resolution period. In the event that either or both of the parties refuses to enter into the mandatory binding resolution period, third party facilitator 42 may issue 254 a public service announcement that publicly discloses: the allegation made against the accused member/non-member; that the parties are currently in a dispute that cannot be internally settled; and that either or both of the parties refused to enter into the mandatory binding resolution period. Typically, this public service announcement is made via e.g., a web site maintained by the third-party facilitator 42, a press release, a trade publication/journal, and/or a general or industry-specific newspaper/magazine, for example.

Conversely, in the event that the parties (involved in the above-described non-binding resolution period) agree to enter into the mandatory binding resolution period, the issuance of a public service announcement is avoided and code module 62 initiates 256 the mandatory binding resolution period.

This mandatory binding resolution period may include adjudication, binding arbitration, and/or any other commonly recognized forms of binding alternative dispute resolution. Further, this mandatory binding resolution period is typically an expedited procedure (e.g., twenty-eight days), and the adjudicators/arbitrators employed are typically members of an alternative dispute resolution organization, such as the American Arbitration Association. Alternatively, the service providers and customers may be contractually obligated to act as adjudicators/arbitrators and assist in settling disputes arising between other service providers and customers.

During this mandatory binding resolution period, one or more of the above-described dispute resolution procedures may be employed. For example, during a twenty-eight day mandatory binding resolution period, the first seven day period may employ mediation (i.e., low pressure and not binding on the parties); the second seven day period may employ non-binding arbitration (i.e., higher pressure and not binding on the parties); and, if still not resolved, the last fourteen day period may employ binding arbitration (i.e., higher pressure and binding on the parties). Typically, by the expiry of the mandatory binding resolution period, the dispute must be resolved.

Once resolved, the accusing member and the accused member/non-member must agree 258 to abide by the decision of the dispute resolution procedure. In the event that either party refuses to abide by the decision, third party facilitator 42 may issue 260 a public service announcement (e.g., a press release) that publicly discloses: the allegation made against the accused member/non-member; the decision of the dispute resolution procedure; and the refusal of the accusing member and/or the accused member/non-member to abide by the decision of the dispute resolution procedure. Typically, this public service announcement is made via e.g., a web site maintained by the third-party facilitator 42, a press release, a trade publication/journal, and/or a general or industry-specific newspaper/magazine, for example.

Additionally, if at some point in the future, if the accusing member and/or the accused member/non-member subsequently ceases to abide 262 by the decision of the dispute resolution procedure, third party facilitator 42 may issue 264 a public service announcement (e.g., a press release) that publicly discloses: the allegation made against the accused member/non-member; the decision of the dispute resolution procedure; and the refusal of the accusing member and/or the accused member/non-member to continue to abide by the decision of the dispute resolution procedure. Typically, this public service announcement is made via e.g., a web site maintained by the third-party facilitator 42, a press release, a trade publication/journal, and/or a general or industry-specific newspaper/magazine, for example.

Disclosures:

Disclosures help protect the public and the integrity of an end product by compelling both members and non-members (of organization 44) within the market that produced the end product to demonstrate a higher-level of integrity in their dealings with other market participants.

Point of Consumption Disclosures: These disclosures are included within the end product produced by members (i.e., service providers) of organization 44. For example, if the end product produced is a technical research report, the cover of the research report may include an annotation or seal stating that the product was produced by members of organization 44. This notation or seal may further state that the members of organization 44 are e.g., bound by a code of conduct. Alternatively, if the end product produced is an addition on a house, the customer may be presented with a certificate that certifies that the addition was constructed by members of organization 44. This certificate may then be used, during resale of the house, to bolster the sale price. If the end product produced is securities analysis that results in the issuance of a buy/sell/hold rating for a particular security, the annotation/seal may be placed on the front cover of the report, informing the reader that the report was prepared by a member of organization 44, who is/are bound by a code of conduct. Further, the annotation/seal may provide information about that analyst(s) performance statistics (as described above) or the analyst's market capitalization breakdown (as described above), for example.

Web-based Disclosures: Web-based disclosures harness market forces to put pressure on, encourage and provide incentives for behavior that improves the integrity of the end product produced.

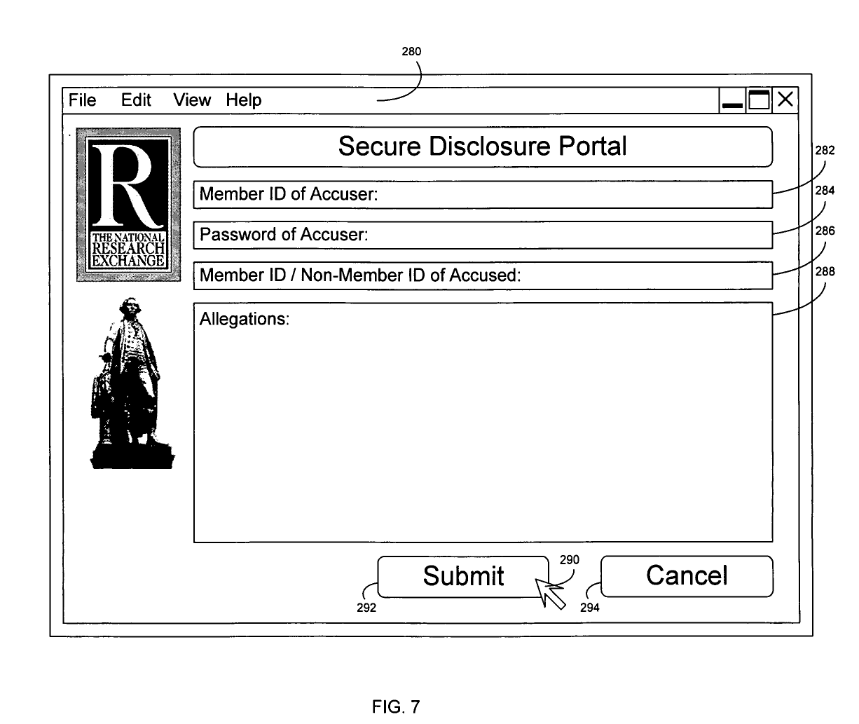

Referring also to FIG. 7 and as discussed above, whenever a member believes that: another member is in violation of the code of conduct; or a non-member is behaving in a manner that may potentially undermine the integrity of the end product, these allegations are typically reported via a disclosure screen 280 that is executed by code module 62 and rendered by user interface module 56. Disclosure screen 280 is a portion of the secure website (not shown) maintained by third-party facilitator 42. Depending on the manner in which system 10 is configured by administrator 36, the reporting of these allegations may be mandatory (i.e., the member is required to report) or voluntary (i.e., the member may choose to report). Additionally, third-party facilitator 42 may institute sanctions (e.g., against service provider 18, 20, 22 and/or customer 12, 14, 16) if a false/misleading claim is filed.

Disclosure screen 280 allows a member to make a disclosure by e.g., providing their Member ID (via field 282) and Member Password (via field 284) for identification and authentication purposes. Additionally, website 280 allows the member to identify (via field 286) the other member or non-member that is allegedly violating the code of conduct and/or acting in a manner that may potentially jeopardize the integrity of an end product. Further, website 280 allows the accusing member to summarize the suspect behavior within field 288. Once the appropriate fields are populated, the member may select the “submit” button 292 (via a screen pointer 290 that is controllable by a pointing device such as a computer mouse, not shown), which completes the submission process. Code module 62 then initiates the dispute resolution process described above. Alternatively, the member may abort the submission process by selecting the “cancel” button 294 with screen pointer 290.

As described above, once a member makes an allegation against another member, the dispute resolution process is initiated and the parties are given a defined period of time (i.e., the voluntary resolution period) to resolve the matters confidentially amongst themselves. In the event that an impasse is reached, the parties enter into the mandatory resolution period, in which a dispute resolution procedure (e.g., mediation, arbitration, or binding arbitration, for example) is used to resolve the matter.

Searching:

As discussed above, once a service provider is deemed qualified for admission into database 52, the service provider enters into a contract with third-party facilitator 42 to become a member of organization 44. Once a member of organization 44, administrator 36 configures and populates one or more database records with the pertinent information required to properly identify the service provider within database 52. Additionally and as discussed above, when a customer (e.g., customers 12, 14, 16) wishes to obtain paid-for services from one of the service providers (e.g., service providers 18, 20, 22) listed within database 52, the customer must enter into a contract with third-party facilitator 42 and become a member of service management organization 44.

When researching service providers listed within database 52, the customer (e.g., customer 12) accesses service management system 10 via customer computer 32 that is connected to network 26 (or network 28). Customer computer 32 (via user interface module 56) accesses searching module 54, which allows customer 12 to define queries for searching database 52. Searching module 54 may include: a traditional search engine (e.g., a localized version of the Google™ or Yahoo™ search engines); or a standard SQL (i.e., Structured Query Language) search engine that allows customer 12 to compose structured search strings.

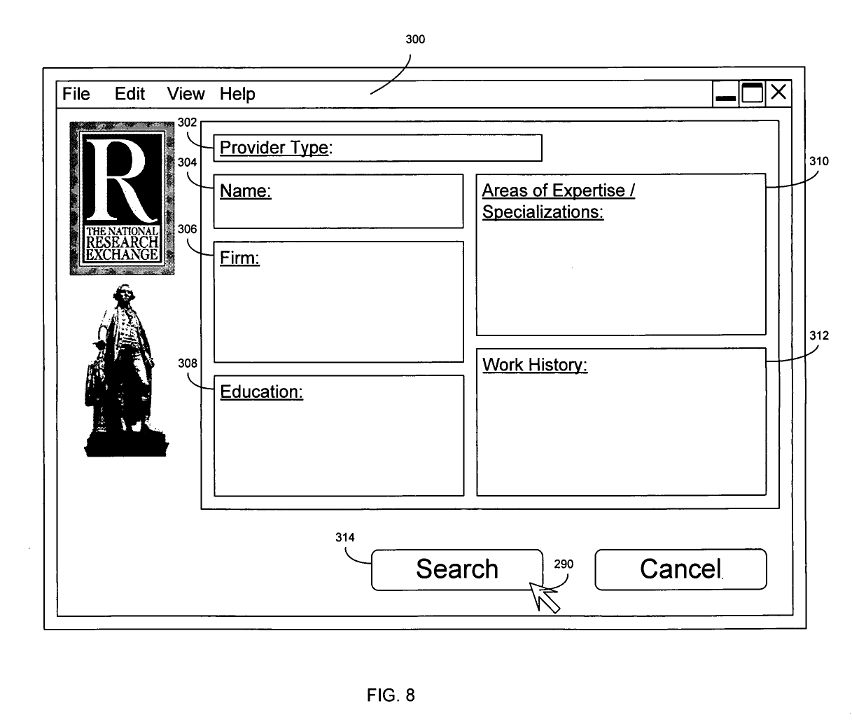

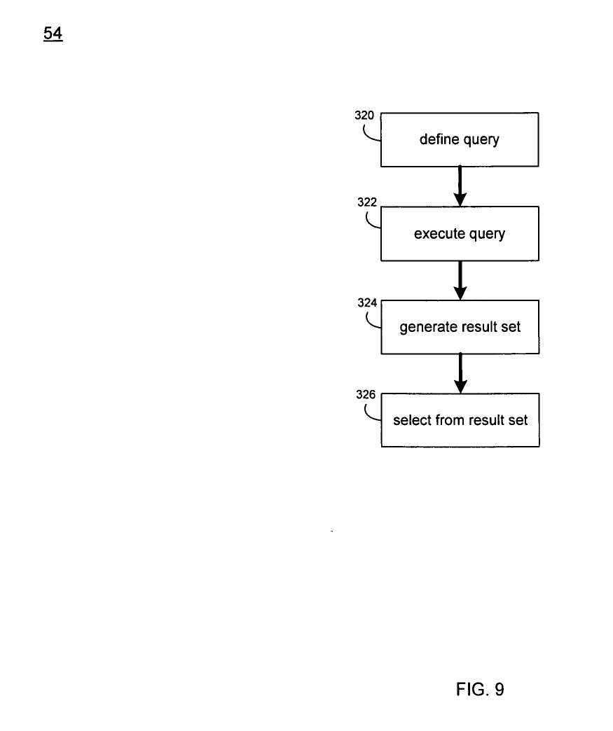

Referring also to FIGS. 8 and 9, once searching module 54 is accessed by customer 12, the customer is presented with a search screen 300 (which is rendered by user interface module 56) that includes the various data fields 302, 304, 306, 308, 310, 312 that may be used by customer 12 to define 320 a query (using query generation module 330 of searching module 54). As with traditional search engines, wild card descriptors (e.g., “*”, and “!”, for example) may be used to broaden search terms. Additionally, a blank field may be interpreted as a field wild card descriptor. Therefore, if all fields within search screen 300 are left blank and “search” button 314 is selected using screen pointer 290, the result set generated by searching module 54 would typically include each data record within database 52. Accordingly, it may be desirable to narrowly construe searches so that the result sets generated are manageable in size.

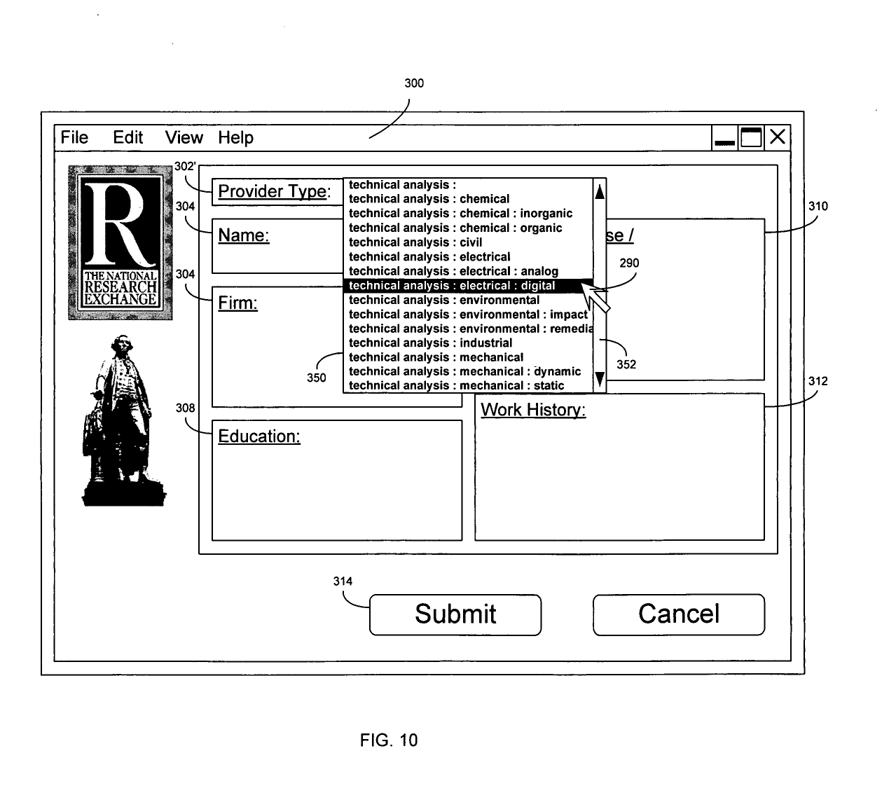

In addition to manually-typed entries within search screen 300, one or more of the search fields may include drop-down menus that allow the customer to select from a defined number of choices. For example and as shown in FIG. 10, drop down menu 350 allows customer 12 to scroll (using scroll bar 352) through the possible choices concerning e.g., data field 302′ (i.e., the provider-type field). The customer may then select the desired choice from drop down menu 350, thus populating the “provide type” data field 302′.

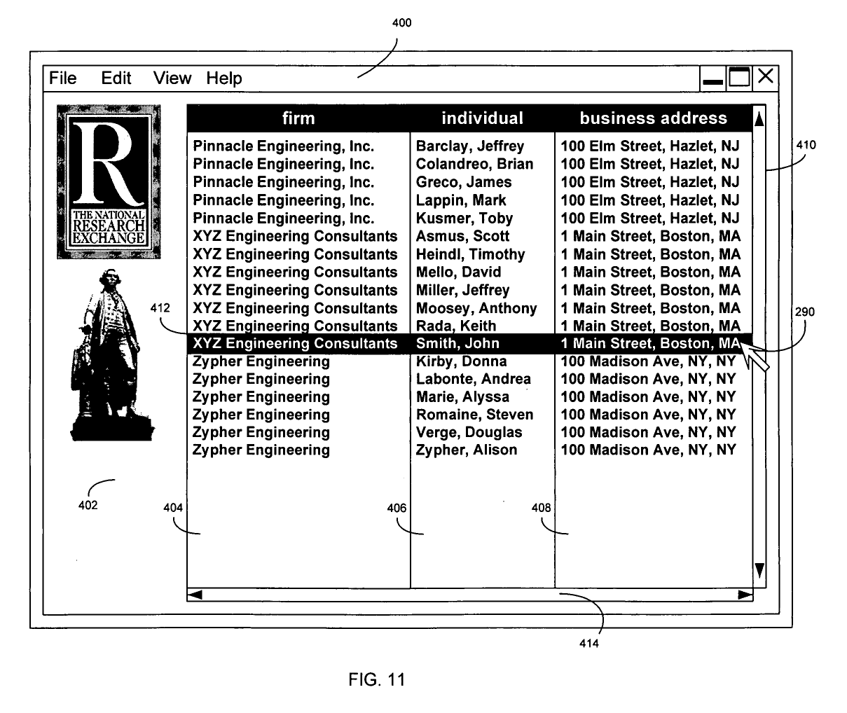

Once a query is defined 320 and submitted, searching module 54 executes 322 the query (using query execution module 332) by searching the data records of database 52 and generating 324 a result set (using result generation module 334 of searching module 54) from which the customer may select 326 a service provider. Referring also to FIG. 11, a typical result screen 400 is shown, as rendered by user interface module 56. Result screen 400 typically includes a list of records 402 that match the search criteria entered by the member. List of records 402 may be apportioned into columns (e.g., columns 404, 406, 408) that define e.g., the firm name, individual name, and address of the service provider(s). A vertical scroll bar 410 allows customer 12 to scroll through the list of records 402 if the result set is large enough to fill more than one result screen. Using screen pointer 290, customer 12 may select 326 one or more of the line items (e.g., line item 412) included within the list of records 402 of result screen 400.

While list of records 402 is shown to include three columns, this is for illustrative purposes only, as other configurations are possible. For example, in addition to columns 404, 406, 408 described above, other columns may also be included in result screen 400 that e.g., correspond to the various terms defined in the query. For example and as discussed above, the various data records (e.g., data record 150) included within database 52 may include fields corresponding to a market capitalization breakdown 162, a current performance statistic 164, and/or a long-term performance statistic 166. Accordingly, when result screen 400 is rendered, the list of records 402 may include columns corresponding to these fields. In the event that the number of columns included in list of records 402 exceeds the maximum number of columns simultaneously displayable on result screen 400, a horizontal scroll bar 414 allows customer 12 to view obscured columns not currently viewable on result screen 400.

Typically, list of records 402 may be sorted based on any of the columns included within the list of records, thus allowing the user to alter the manner in which the line items in list of records 402 are ranked. For example, while the records included in list of records 402 are sorted in accordance with the firm name (i.e., column 404), list of records 402 may also be sorted based on individual name (i.e., column 406), business address (i.e., column 408), market capitalization breakdown (not shown), current performance statistic (not shown) or long-term performance statistic (not shown), for example. Accordingly, if customer 12 is interested in sorting list of records 402 to determine which of the service providers specified in list of records 402 has the highest current performance statistic (not shown), customer 12 may simply scroll to the right (using horizontal scroll bar 414) to reveal the current performance statistic column and e.g., click on that column to sort the records (included within list of records 402) based on the value of their current performance static.

Service management system 10 may also include an API (i.e., application program interface; not shown) that allows third-party users (i.e., third-party user 46, FIG. 1) to retrieve data stored within database 52. Third-party user 46 may then incorporate this retrieved data into various products offered by third-party user 46. For example, third-party user 46 may retrieve (from database 52) market capitalization breakdown data for inclusion in a report concerning the top ten U.S. research firms.

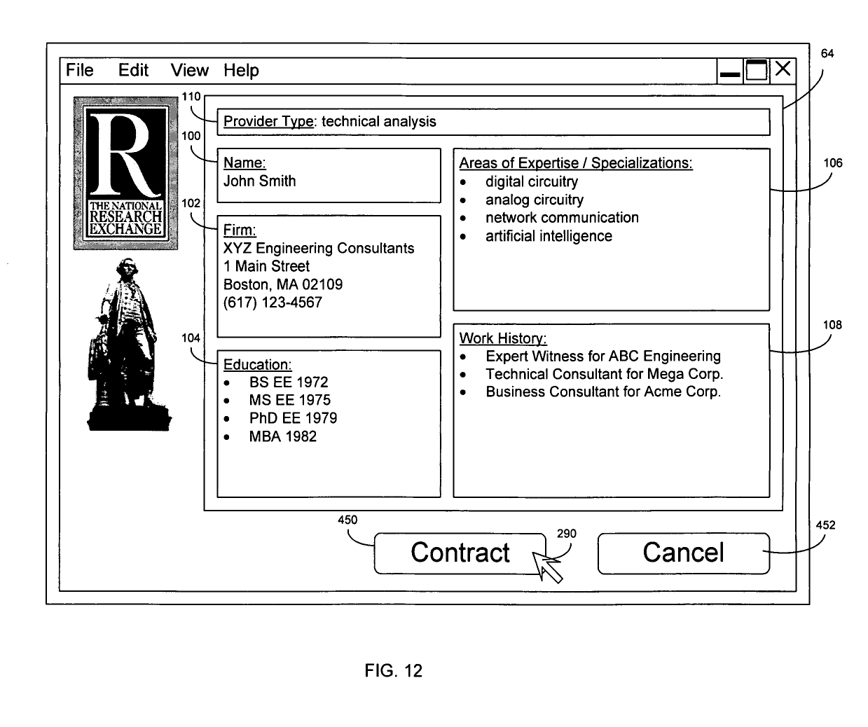

Referring also to FIG. 12, once a line item is selected 326, the data record 450 corresponding to that line item is rendered by user interface module 56 for review by the customer. For example, by selecting line item 412 (i.e., the line item that corresponds to John Smith), the data record belonging to John Smith (i.e., data record 64) is accessed (by data interface module 50) from database 52 and rendered (by user interface module 56) for review by customer 12. Customer 12 may then review the qualifications of the selected service provider (i.e., John Smith) to decide whether the customer wishes to enter into a contract with third-party facilitator 42 to have service provider “John Smith” perform one or more services for customer 12. The contract process may e.g., be initiated electronically by selecting (via screen pointer 290) the “contract button” 452. Alternatively, the contract process may be initiated by contacting third-party facilitator 42 in writing or telephonically.

Contracting:

Once the contracting process is initiated (i.e., the service provider is selected), the service provider is typically contacted by third-party facilitator 42. The contact may be made by simultaneously sending messages to both the third-party facilitator and the selected service provider concerning the customer's desire to obtain services from the selected service provider.

As discussed above, prior to the obtaining the services desired from the selected service provider (e.g., service provider 18), customer 12 is required to enter into a user research contract with third-party facilitator 42. Additionally, prior to being allowed to render services, service provider 18 is required to enter into an analyst research contract with third-party facilitator 42. Alternatively, a single three party contract may be executed, in which the parties to the contract are the customer, the service provider, and the third-party facilitator.

The contract(s) entered into by the customer and the service provider require: the service provider to provide services to the customer for a defined period of time; and require the customer to accept the services rendered by the service provider for the defined period of time; with all the contracting parties being subject to the terms and conditions of the code of conduct (as discussed above).

As discussed above, system 10 (generally) and the code of conduct (specifically) are configured to ensure the integrity of the end product produced by the service provider(s). Accordingly and referring again to FIG. 6, when renewing a contract, a customer may be surcharged 266 if the contract is renewed within the terminal portion of the contract. For example, when configuring system 10, administrator 36 typically defines the terminal portion of a contract. This terminal portion may be a fixed amount of time e.g., a contract cannot be renewed within six months of the expiration date of the contract. Alternatively, the terminal portion of a contract may be configured such that the terminal portion is defined to be a percentage (e.g., 50%) of the contracting period. While the customer is typically allowed 268 to renew the contract during any portion of the contract term, the customer is typically surcharged when renewing the contract during the terminal portion. The surcharge associated with renewing the contract during the terminal portion may be as high as 100% of the contract amount.

Regardless of the manner in which the terminal portion is defined, by encouraging the customer to renew their contract a significant amount of time prior to the expiry of the contract, the ability of the customer to compromise the integrity of the end product is reduced.

In addition to surcharging customers that renew their contract during the terminal portion of the contract, each contract entered into by the customer may require 270 that the customer accept multiple bundles of services (i.e., multiple discrete service projects) from the service provider during the term of the contract.

As above, by requiring that the customer accept multiple bundles of services, the ability of the customer to compromise the integrity of the end product is reduced. For example, assume that customer 12 (i.e., a publicly-traded company that issues stocks) and service provider 18 (i.e., a securities analyst) enter into contracts with third-party facilitator 42 for research concerning the stocks issued by customer 12 and the issuance of a buy/sell/hold recommendation concerning the stocks. If customer 12 and service provider 18 are required to enter into contracts for multiple recommendations (e.g., issuing a buy/sell/hold recommendation twice per year for two years), the ability of the service provider to be unbiased is enhanced, as the service provider may issue an unfavorable recommendation (i.e., a hold/sell recommendation) without fear of the customer deciding not to renew the research contract. Additionally, as the service provider is somewhat shielded from the threat of not renewing the contract, the customer is less likely to try to intimidate the service provider into issuing a favorable (i.e., buy) recommendation.

Additionally, when entering into a contract, the contract entered into by the service provider may prohibit 272 (and/or require the disclosure of) potentially-suspect third-party business relationships, such as: investment banking relationships; commercial banking relationships; money management relationships; investment management relationships; and any other commercial relationship that may be deemed material to evaluating the independence of research, for example.

Service Provider Selection:

While the system is described above as if the customer selects the specific service provider whom the customer wishes to employ, this is for illustrative purposes only and other configurations are possible. For example, the customer may contract with third-party facilitator 42 for the desired/required services and delegate the service provider selection process to third-party facilitator 42.

As discussed above, administration and maintenance module 58 allows administrator 36 to configure and maintain database 52 so that information concerning service providers 18, 20, 22 can be stored in a logical and searchable fashion (via searching module 54). When researching service providers listed within database 52, the customer (e.g., customer 12) typically accesses service management system 10 via customer computer 32 that is connected to network 26 (or network 28). The customer may then define 320 and execute 322 a query and generate 324 a result set to search database 52 for a qualified service provider. Upon finding one, the customer may then select 326 one or more qualified service providers and contract with them to perform services. Examples of typical customers include individuals, corporations, agents, investors, institutions, and/or sponsors, for example.

However and as discussed above, the customer may not be interested in searching for, qualifying, and selecting one or more service providers. Further, being system 10 (generally) and the code of conduct (specifically) are configured to ensure the integrity of the end product produced by the service provider(s), the customer may be apprehensive about selecting the service provider.

For example, assume that database 52 defines a pool of qualified analysts, each of which is capable of providing paid-for research concerning a specific company. This pool of qualified analysts may include every analysts listed within database 52, or only a portion thereof. Accordingly, separate pools of qualified analysts may be established for various technology sectors, business sectors, or market capitalization ranges, for example.

As discussed above, the specific company may operate within a specific business sector, such as: the securities industry; the health care services industry; the business products industry; the business services industry; the consumer products industry; the consumer services industry; the medical products industry; the medical services industry; the energy industry; the insurance industry; the contracting industry; the transportation industry; the pharmaceutical industry; the environmental industry; the technology products industry; the technology services industry; the telecom products industry; the telecom services industry; the financial products industry; the financial services industry; the academic services industry; and the entertainment industry.

Continuing with the above-stated example, the customer (e.g., customer 12) may be interested in having a research project produced concerning the specific company. However, assume that customer 12 is uncomfortable with selecting the specific analyst(s) to perform the research project. As discussed above, customer 12 may not feel qualified to make the selection, or may not have time to perform the required research. Alternatively or additionally, customer 12 may wish to have a neutral third-party make the selection in order to avoid any appearance of impropriety.

Therefore, customer 12 may delegate the selection process to third-party facilitator 42 so that third-party facilitator 42: defines 320 the query; executes 322 the query (generating 324 the result set); and selects 326 one or more analysts (from the pool of qualified analysts) to produce the research project concerning the specific company. Accordingly, by allowing third-party facilitator 42 to select the analysts, the potential for market manipulation is minimized and the public is better protected, as the probability of the research project being unbiased is enhanced.

Typically, the selection process is handled by a neutral selection panel/board within third-party facilitator 42. The individual member within the neutral selection panel/board may be e.g., appointed or elected (depending on the particular manner in which third-party facilitator 42 is organized).

The research project may require the generation of one or more discrete research products. For example, the research project may concern securities analysis and may require:
the generation of a single buy/sell/hold recommendation for a single security issued by the specific company;
the generation of e.g., four separate and independent buy/sell/hold recommendations for a single security issued by the specific company, such that recommendations are prepared concurrently and each authored by a different analyst;
the generation of a single buy/sell/hold recommendation for each of e.g., three securities issued by the specific company, such that the recommendations are prepared concurrently and each authored by different analyst;
the generation of e.g., four separate and independent buy/sell/hold recommendations for a single security issued by the specific company, such that the recommendations are prepared consecutively at predefined intervals (e.g., every six months) and authored by a single analyst; and/or
the generation of e.g., four separate and independent buy/sell/hold recommendations for a single security issued by the specific company, such that the recommendations are prepared consecutively at predefined intervals (e.g., every six months) and each authored by a different analyst.

The above list is not intend to be all inclusive and is merely intended to illustrate some of the various combinations of discrete research products included within a research project.

As discussed above and continuing with the above-stated example, prior to the obtaining the services desired from the selected analysts (e.g., service providers 18, 20, 22), the customer (e.g., customer 12) is required to enter into a user research contract with third-party facilitator 42. Additionally, prior to being allowed to render services, the selected analysts (e.g., service providers 18, 20, 22) are each typically required to enter into an analyst research contract with third-party facilitator 42. Alternatively, a single multi-party contract may be executed, in which the parties to the contract are the customer (e.g., customer 12), each of the service providers (e.g., service providers 18, 20, 22), and third-party facilitator 42.

In addition to securities analysis, the specific company may be the producer of a product offered for sale and the customer (e.g., customer 12) may be interested in obtaining paid-for research concerning the product offered for sale. Examples of the product offered for sale include: a consumer product; a business product; a medical product; an energy product; an insurance product; a contracting product; a transportation product; a pharmaceutical product; a technological product; a telecom product; a financial product; an academic product; and an entertainment product.

Alternatively, the specific company may be a provider of a service and the customer (e.g., customer 12) may be interested in obtaining paid-for research concerning the service. Examples of the service include: a consumer service; a business service; a health care service; a hospital service; a rehabilitative service; a long-term care service; a medical service; an energy service; an insurance service; a contracting service; a transportation service; a pharmaceutical service; an entertainment service; a technological service; a telecom service; a financial service; an academic service; and an environmental service.

Research Funding:

As discussed above, most public companies no longer generate sufficient trading and commission revenue to naturally attract adequate sell-side equity research coverage, thus resulting in a broad decline in the depth and breadth of “coverage” of public companies. Further, if a public company implicitly contracts for equity research via underwriting engagements with investment banking institutions, the public company risks losing the benefit of the paid-for research, as the integrity, accuracy, and independence of the research may be brought into question.

As is known in the art, investment banks (and investment bankers) are individuals and/or institutions that typically act as managers, underwriters and/or agents for corporations and municipalities issuing securities. Investment banks may also: maintain the broker/dealer operations (as described below); maintain markets for previously issued securities: offer advisory services to investors; and/or participate in facilitating mergers and acquisitions, private equity placements and corporate restructuring.

When a company wishes to raise capital, a offering of a security may be made, which makes new shares of the security available to the investing public. Depending on the timing, the offering may be referred to as an initial offering (i.e., the initial offering of shares of a security from the issuer of the security to the investing public) or a subsequent offering (i.e., any offering of shares of the security from the issuer of the security to the investing public, subsequent to the initial offering). Additionally, this offering may be a public offering (e.g., an offering in which anyone may purchase shares of the security) or a private placement (e.g., a offering in which only a limited number of investors may purchase shares of the security).

Typically, when an offering is made for an issuer of a security, the per-share price paid by the investing public for each share of the security is greater than the per-share price paid to the issuer of the security. For example, if during an initial offering, the per-share price paid by the investing public is $17.00, the per-share price paid to the issuer of the security may be $15.50, resulting in a per-share profit of $1.50 for the underwriter (e.g., the investment bank) of the offering. This profit is typically referred to as the gross spread, which may be divided into a management fee, an underwriting fee, and a selling concession. While the manner in which the gross spread is divided may vary, a typical split is a 20% management fee, a 20% underwriting fee, and a 60% selling concession.

The procurement of equity research for an offering of a security (e.g., an initial offering and/or a subsequent offering) may be an important element for the success of the offering, both during the offering and after the offering has completed. Accordingly, when choosing an investment bank to manage the offering, the issuer of the security may e.g., take into consideration the manner in which research coverage may be provided during and after the offering.

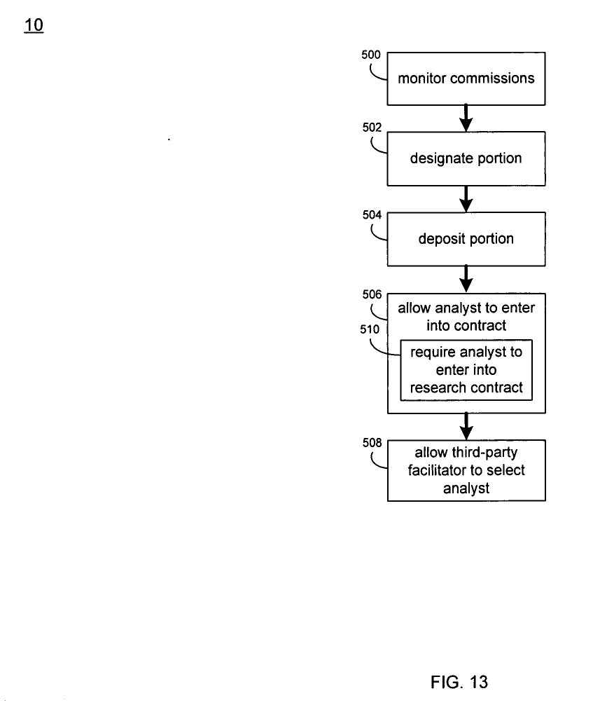

Referring also to FIG. 13, service management system 10 may monitor 500 commissions generated during an offering of a security. As discussed above, the offering may be e.g., a public offering (i.e., initial or subsequent) or a private placement (i.e., initial or subsequent). The security offered may be e.g., a stock, a derivative security of a stock, a bond, and/or a derivative security of a bond, for example. The commissions generated may include e.g., the gross spread of the offering. Typically, the gross spread is approximately 7% of the value of the offering. For example, if a single share of a security is traded for $10.00 during an offering, the issuer of the security may only receive $9.30 and $0.70 of each $10.00 share price may be the gross spread, which is paid to e.g., the investment bank. As discussed above, a typical split for the gross spread is a 20% management fee, a 20% underwriting fee, and a 60% selling concession.

Service management system 10 may designate 502 a portion of the commissions generated for funding of paid-for research concerning the security that is the subject of the offering. This designated portion may be a defined percentage (e.g., 10%) of the commissions generated, or a defined dollar amount of the commissions generated (e.g., $100,000). For example, if 5,000,000 shares of Security X were offered in an offering and traded for a total of $50,000,000 (i.e., an average price of $10.00 per share), assuming a typical gross spread of 7.00%, $3,500,000 in commissions would be generated. Assuming that the portion designated 502 to fund paid-for research is 10.00%, $350,000 would be designated 502 for paid-for research. This designated portion (e.g., $350,000) may be deposited 504 into a paid-for research account and held in trust for future research concerning the security (e.g., Security X).

Third-party facilitator 42 may establish a broker/dealer 48 (FIG. 1) that is a subsidiary of third-party facilitator 42. As is known in the art, a broker/dealer is an individual or firm in the business of buying and selling securities for itself and others. Broker/dealers typically are required to register with the SEC (i.e., Securities & Exchange Commission). When a broker/dealer is acting as a broker, the broker/dealer typically acts as an intermediary between a buyer and a seller of a security and executes security orders on behalf of the buyer/seller of the security. When a broker/dealer is acting as a dealer, the broker/dealer typically executes orders on behalf of the broker/dealer, such that the traded securities may: be sold to clients of the broker/dealer; be sold to other broker/dealers, or become part of the holdings of the broker/dealer.

The paid-for research account (into which e.g., the $350,000 is deposited) may be managed by third-party facilitator 42 and/or broker/dealer 48. Since (as discussed above) third-party facilitator 42 is capable of facilitating the generation of paid-for research concerning Security X, if third-party facilitator 42 manages the paid-for research account, third-party facilitator 42 may define e.g., the granularity and frequency of the research generated for e.g., Security X and select one or more analysts (from the pool of qualified analysts) to perform the research. Additionally/alternatively, if broker/dealer 48 manages the paid-for research account, broker/dealer 48 may define e.g., the granularity and frequency of the research generated for e.g., Security X and select one or more analysts (from the pool of qualified analysts) to perform the research. This research may then be facilitated through third-party facilitator 42.

As discussed above, once it is determined that an analyst meets or exceeds the standards for admission into database 52 (FIG. 2), the analyst is typically allowed 506 to enter into a contract with third-party facilitator 42. The analyst is then entered into database 52 (i.e., the pool of qualified analysts) and becomes a member of service management organization 44 maintained and administered by third-party facilitator 42. As discussed above, if an analyst is selected 508 (by e.g., third-party facilitator 42 or broker/dealer 48) to generate paid-for research for e.g., Security X, the selected analyst may be required 510 to enter into an analyst research contract that requires the selected analyst to provide the paid-for research concerning the security.

As discussed above, the designated portion (e.g., $350,000) of the commissions may be deposited 504 into a paid-for research account and held in trust for future research for the security (e.g., Security X). This future research may require the generation of one or more discrete research products that may occur during or after the offering that generated the commissions. Accordingly, by using the designated portion to fund future research for the security, the availabliltiy of future research concerning the security is ensured.

The future research may concern: a single research product produced by a single selected analyst chosen from the members of the pool of qualified analysts; a plurality of research products concurrently produced by a plurality of selected analysts chosen from the members of the pool of qualified analysts; a plurality of research products consecutively produced by a single selected analyst chosen from the members of the pool of qualified analysts; and/or a plurality of research products consecutively produced by a plurality of selected analysts chosen from the members of the pool of qualified analysts.

Research Follow-Up:

As discussed above, investment banks (and investment bankers) are individuals and/or institutions that typically act as managers, underwriters and/or agents for corporations and municipalities issuing securities. Investment banks may also: maintain the broker/dealer operations (as described above); maintain markets for previously issued securities: offer advisory services to investors; and/or participate in facilitating mergers and acquisitions, private equity placements and corporate restructuring.

Further, when a company wishes to raise capital, an offering of a security may be made, which makes new shares of the security available to the investing public in the form of an offering. Equity offering types may include: private placements; private placements in public equities, initial offerings, and subsequent offerings, for example. Debt offering types (which may be either private or public offerings) may include: commercial paper facilities, senior secured credit revolvers, bond offerings, debenture offerings, offerings of asset-backed securities, offerings of mortgage-backed securities, and high yield bonds, for example. Hybrid security offerings may include: preferred securities, and convertible securities, for example.

As discussed above, the procurement of equity research for an offering of a security (e.g., an initial offering and/or a subsequent offering) may be an important element for the success of the offering, both during the offering and after the offering has completed. Accordingly, when choosing an investment bank to manage the offering, the issuer of the security (i.e., the company) may e.g., take into consideration the manner in which research coverage is likely to be provided during the offering (i.e., in the case of some foreign jurisdictions where research coverage is permitted during offerings) and after the offering, thus reducing the chance of the company being abandoned after the offering. While coverage during an offering is generally prohibited in the United States, the belief by investors during an offering that coverage is likely to be initiated may be important to the success of the offering

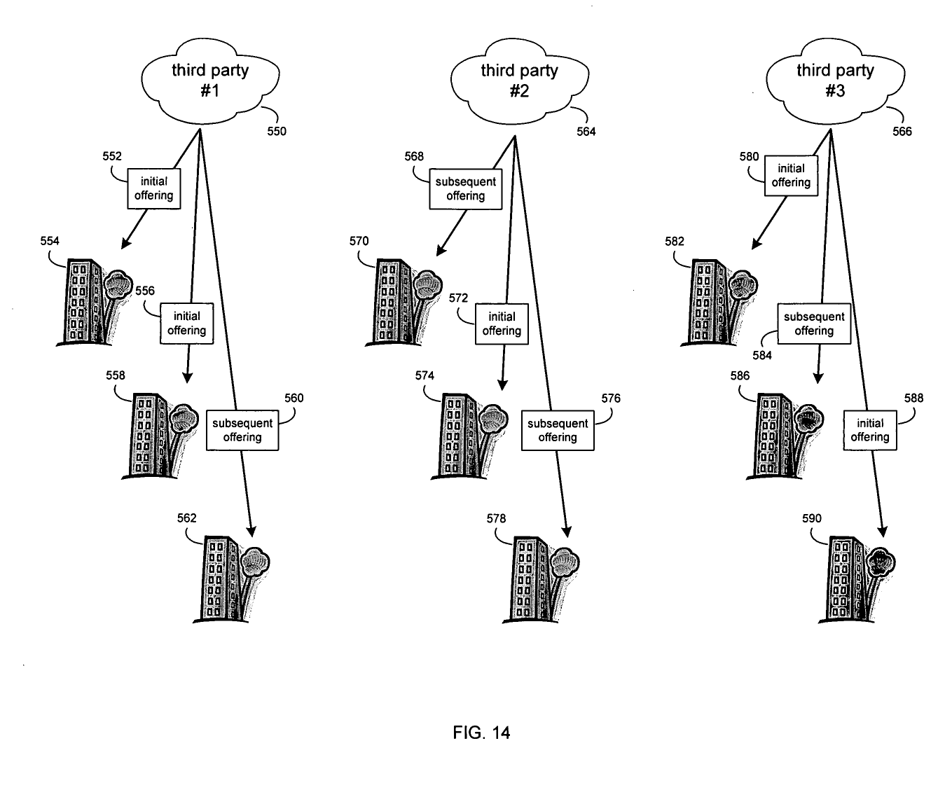

Accordingly and referring also to FIGS. 14 & 15, whenever a third-party (e.g., an investment bank; an underwriter; and/or an agent) 550 participates in an offering (i.e., a transaction) 552 concerning a company 554, service management system 10 may monitor 600₁₋ₙ the level of research coverage initiated by the third-party during and after the occurrence of the offering (which will be discussed below in greater detail).

Examples of company 554 may include a company wishing to raise capital through offering 552, examples of which include: an initial public offering; a subsequent offering; a private investment in public equity transaction; a debt offering; a convertible offering, and a real estate investment trust offering.

Company 554 may be a manufacturer of goods and/or a provider of services within e.g., the securities industry; the health care industry; the medical industry; the energy industry; the insurance industry; the manufacturing industry; the contracting industry, the transportation industry; the pharmaceutical industry; the environmental industry; the telecom industry; the financial industry; the academic industry; and the entertainment industry, for example.

Typically, company 554 engages third-party 550 to manage offering 552. During offering 552, third party 550 may function as e.g., a book running manger, a lead manager, a co-manager, an underwriter, a selected dealer, an advisor, or a co-advisor, for example.

Third-party 550 may be simultaneously and/or sequentially involved in multiple offerings. For example, in addition to third-party 550 handling initial offering 552 for company 554, third-party 550 may also handle e.g., initial offering 556 for company 558 and e.g., subsequent offering 560 for company 562.

Further, other third-parties (e.g., third-party 564 and third party 566) may handle offerings for other companies. For example, third-party 564 may handle: subsequent offering 568 for company 570; initial offering 572 for company 574; and subsequent offering 576 for company 578. Further, third-party 566 may handle: initial offering 580 for company 582; subsequent offering 584 for company 586; and initial offering 588 for company 590.

As discussed above, when a company (e.g., company 554) is choosing a third-party (e.g., an investment bank, an underwriter; and/or an agent) to manage an offering, the company may take into consideration the manner in which research coverage is likely to be provided during and after the offering. This, in turn, reduces the chance of the company being abandoned after the offering.

Specifically, companies typically engage the services of the third-party (e.g., third-party 550) with the hope that the company will receive ongoing equity research coverage. However, as the quantity and duration of research coverage is typically not the subject of a contract (but rather an implied promise or policy of the third-party), the ability to understand the probability that research coverage will be sufficiently provided is a highly relevant factor when a company is choosing which of a plurality of third-parties to engage for a specific transaction.

Accordingly, service management system 10 may monitor 600₁₋ₙ the level of research coverage initiated by various third-parties (e.g., third party 550, 564 and/or 566) on behalf of various companies (e.g., companies 554, 558, 562, 570, 574, 578, 582, 586, 590) during and after the occurrence of various offerings (e.g., offerings 552, 558, 562, 568, 572, 576, 580, 584, 588, respectively).

Monitoring 600₁₋ₙ the level of research coverage initiated by a third party (e.g., third-party 550) may include: determining 602 a coverage initiation quantifier for the research coverage initiated by e.g., third party 550 concerning e.g., company 554; determining 604 a coverage duration quantifier for the research coverage initiated by e.g., third party 550 concerning e.g., company 554; and determining 606 a coverage depth quantifier for the research coverage initiated by e.g., third party 550 concerning e.g., company 554.

While the process of determining 602 a coverage initiation quantifier, the process of determining 604 a coverage duration quantifier, and the process of determining 606 a coverage depth quantifier are only shown to be included within the process of monitoring 600, the coverage level, this is for illustrative clarity only and is not intended to be a limitation, as processes 602, 604, 606 may also be included within e.g., processes 6002 n.

The process of determining 602 a coverage initiation quantifier (as executed by service management system 10) may determine how soon after the offering (i.e., the transaction) the third-party (e.g., the investment bank) initiated research coverage. Accordingly, the process of determining 602 a coverage initiation quantifier (as executed by service management system 10) may includes one or more of:
determining if the role of the third-party impacts the research coverage initiated by the third-party concerning the company;
determining if the industry of the company impacts the research coverage initiated by the third-party concerning the company;
determining if the size of the company impacts the research coverage initiated by the third-party concerning the company;
determining if the size of the transaction impacts the research coverage initiated by the third-party concerning the company;
determining if the size of the fee paid by the company impacts the research coverage initiated by the third-party concerning the company; and
determining if the type of transaction impacts the coverage initiated by the third-party concerning the company.

The process of determining 604 a coverage duration quantifier (as executed by service management system 10) may determine how long after the offering (i.e., the transaction) the third-party (e.g., the investment bank) terminates coverage. Accordingly, the process of determining 604 a coverage duration quantifier (as executed by service management system 10) may include:
determining if the role of the third-party impacts the research coverage initiated by the third-party concerning the company;
determining if the industry of the company impacts the research coverage initiated by the third-party concerning the company;
determining if the size of the company impacts the research coverage initiated by the third-party concerning the company;
determining if the size of the transaction impacts the research coverage initiated by the third-party concerning the company;
determining if the size of the fee paid by the company impacts the research coverage initiated by the third-party concerning the company; and
determining if the type of transaction impacts the coverage initiated by the third-party concerning the company.

When determining 606 a coverage depth quantifier, various factors may be considered. For example, the process of determining 606 a coverage depth quantifier may e.g., determine the actual number of days that a third party (e.g., an investment bank) provided research coverage for a company, with respect to the total number of days (based upon a criteria set) that the third-party could have provided research coverage for the company. Additionally, the process of determining 606 a coverage depth quantifier may e.g., determine the frequency at which research was generated (e.g., monthly, quarterly, yearly, etc.) and/or the total number of research projects generated per unit time period (e.g., per year), for example. Further, the process of determining 606 a coverage depth quantifier (as executed by service management system 10) may include:
determining if the role of the third-party impacts the research coverage initiated by the third-party concerning the company;
determining if the industry of the company impacts the research coverage initiated by the third-party concerning the company;
determining if the size of the company impacts the research coverage initiated by the third-party concerning the company;
determining if the size of the transaction impacts the research coverage initiated by the third-party concerning the company;
determining if the size of the fee paid by the company impacts the research coverage initiated by the third-party concerning the company; and
determining if the type of transaction impacts the coverage initiated by the third-party concerning the company.

The above-referenced criteria set may take into consideration one or more of the following: the role that the third-party played in the transaction (e.g., book running manger, lead manager, co-manager, underwriter, selected dealer, no role, advisor, and/or co-advisor, for example), a date range, a time-based trend comparison (e.g., compare performance for 2000 vs. 2001 vs. 2002 vs. 2003 vs. 2004, for example); an industry classification; a company size; and an index inclusion, for example.

Further, the process of determining 606 a coverage depth quantifier may e.g., determine the total number of pages or research coverage written by the third-party or an agent of the third party (e.g., a research provider) over a specified period of time. Additionally, the process of determining 606 a coverage depth quantifier may e.g., determine the frequency of reports issued by the third-party or an agent of the third party (e.g., a research provider) over the specified period of time.

Service management system 10 may assign 608₁₋ₙ a score to one or more of the third-parties based, at least in part, upon the level of research coverage initiated by the third-party concerning the company for which the third-party is handling an offering. As discussed above, monitoring 600₁₋ₙ the level of research coverage initiated by a third party may include: determining 602 a coverage initiation quantifier for the research coverage initiated by the third party concerning the company; determining 604 a coverage duration quantifier for the research coverage initiated by the third party concerning the company; and determining 606 a coverage depth quantifier for the research coverage initiated by the third party 550 concerning the company. These quantifiers may be used by service management system 10 when assigning 608₁₋ₙ a score to a third-party. Service management system 10 may then use the above-described score for each of a plurality of third-parties to rank 612 the third-parties with respect to each other (to be discussed below in greater detail).

Continuing with the above example, assume that third party 550 (i.e., third party #1) is handling initial offering 552 for company 554, initial offering 556 for company 558, and subsequent offering 560 for company 562. Further, assume that third-party 564 (i.e., third party #2) is handling subsequent offering 568 for company 570, initial offering 572 for company 574, and subsequent offering 576 for company 578. Finally, assume that third party 566 (i.e., third party #3) is handling initial offering 580 for company 582, subsequent offering 584 for company 586, and initial offering 588 for company 590.

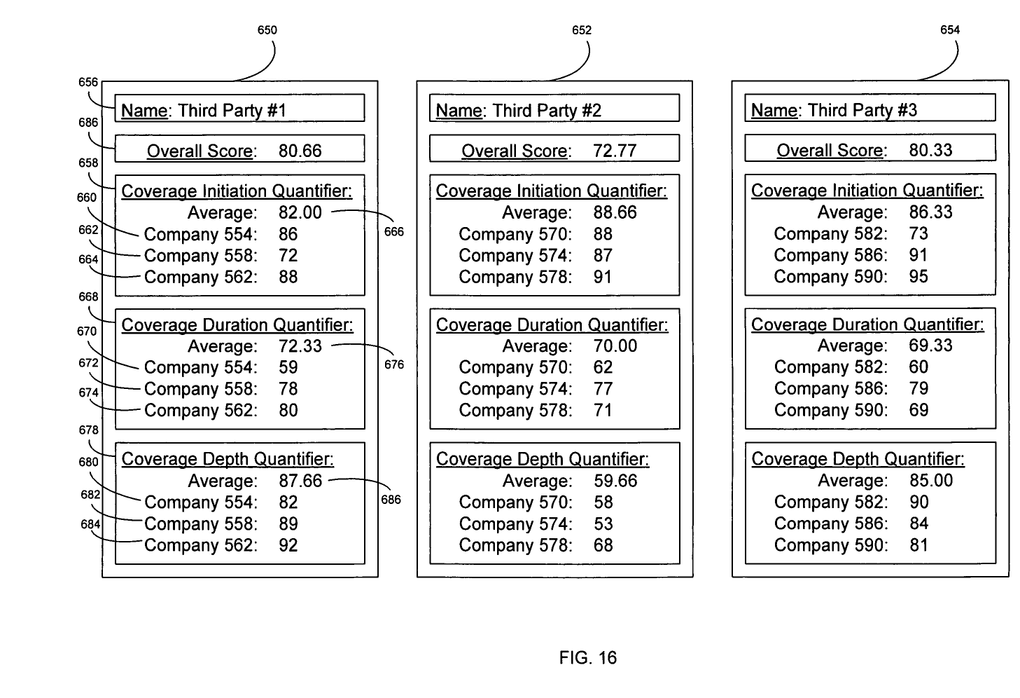

Referring also to FIG. 16, service management system 10 may create a database record 650, 652, 654 for each third party (e.g., third-parties 550, 564, 566, respectively). Each database record may include a name field 656 for identifying the third-party. For example, record 650 identifies third-party 550 (i.e., third party #1), record 652 identifies third-party 564 (i.e., third party #2), and record 654 identifies third-party 566 (i.e., third party #3).

Each data base record may include a coverage initiation quantifier field 658 that defines the coverage initiation quantifier (as described above and as calculated by service management system 10) for each of the plurality of offerings that were handled and/or are currently being handled by the third-party. For example and as discussed above, third-party 550 is handling initial offering 552 for company 554, initial offering 556 for company 558, and subsequent offering 560 for company 562. Accordingly, coverage initiation quantifier field 658 may define a quantifier 660, 662, 664 for each of these three offerings. Further, additional quantifiers may be defined that are e.g., mathematical functions of other quantifiers. For example, a coverage termination quantifier may be defined as the average of the coverage initiation quantifier and the coverage duration quantifier, for example.

Quantifiers 660, 662, 664 may be letter grades, numerical scores, or percentage-based scores, for example. In the particular example, quantifiers 660, 662, 664 are shown to be numerical scores. Coverage initiation quantifier field 658 may further include an average initiation quantifier field 666 that defines the average coverage initiation quantifier for a particular third-party. In this particular example, service management system 10 may determine the numerical average of “86”, “72”, and “88” to be “82.00”, which populates average initiation quantifier field 666.

Each data base record may further include a coverage duration quantifier field 668 that defines the coverage duration quantifier (as described above and as calculated by service management system 10) for each of the plurality of offerings that were handled and/or are currently being handled by the third-party. Since third-party 550 is handling initial offering 552 for company 554, initial offering 556 for company 558, and subsequent offering 560 for company 562, coverage duration quantifier field 668 may define a quantifier 670, 672, 674 for each of these three offerings. Quantifiers 670, 672, 674 may be letter grades, numerical scores, or percentage-based scores, for example. In this particular example, quantifiers 670, 672, 674 are shown to be numerical scores. Coverage duration quantifier field 668 may further include an average duration quantifier field 676 that defines the average coverage duration quantifier for a particular third-party. In this particular example, service management system 10 may determine the numerical average of “59”, “78”, and “80” to be “72.33”, which populates average duration quantifier field 676.

Each data base record may further include a coverage depth quantifier field 678 that defines the coverage depth quantifier (as described above and as calculated by service management system 10) for each of the plurality of offerings that were handled and/or are currently being handled by the third-party. Since third-party 550 is handling initial offering 552 for company 554, initial offering 556 for company 558, and subsequent offering 560 for company 562, coverage depth quantifier field 678 may define a quantifier 680, 682, 684 for each of these three offerings. Quantifiers 680, 682, 684 may be letter grades, numerical scores, or percentage-based scores, for example. In this particular example, quantifiers 680, 682, 684 are shown to be numerical scores. Coverage depth quantifier field 678 may further include an average depth quantifier field 686 that defines the average coverage depth quantifier for a particular third-party. In this particular example, service management system 10 may determine the numerical average of “82”, “89”, and “92” to be “87.66”, which populates average depth quantifier field 686.

An overall score may be calculated (by service management system 10) for each of the third-parties which may be based, at least in part, upon e.g., the average coverage initiation quantifier, average coverage duration quantifier, and/or average coverage depth quantifier. Accordingly, in this particular example, service management system 10 may determine the numerical average of “82.00”, “72.33”, and “87.66” to be “80.66”, which populates overall score field 686.

Database records 650, 652, 654 may be maintained 610 on database 52 by service management system 10. All or a portion of the data used by service management 10 to generate e.g., coverage initiation quantifier, coverage duration quantifier, and/or coverage depth quantifier may be obtained from a third party (e.g., third party 49, FIG. 1).

When ranking 612 third-parties 550, 564, 566, the user (e.g., customer 12, 14, 16) of system 10 may rank the third-parties based on various criteria. For example, third-parties 550, 564, 566 may be ranked by e.g., the overall score, the coverage initiation quantifier, the coverage duration quantifier, and/or the coverage depth quantifier. Additionally, service management system 10 may allow for the filtering of results in accordance with a plurality of additional fields (not shown) included within the database records 650, 652, 654.

For example, the database record of a third-party may define the total number of offerings that the third-party has handled and service management system 10 may allow the user to filter the result set generated to include e.g., only those third-parties that have handled a user-defined minimum number of offerings.

Additionally/alternatively, the database record of a third-party may define the number of offering that the third-party has issued in a particular security class (e.g., micro cap, small cap, mid cap, and/or large cap, for example). Accordingly, service management system 10 may allow the user to filter the result set generated to include only those third-parties in which e.g., at least 50% of their offerings are in mid cap securities.

Additionally/alternatively, the database record of a third-party may define the role (e.g., book running manger, lead manager, co-manager, underwriter, selected dealer, advisor, co-advisor) played by the third-party in each offering. Accordingly, service management system 10 may allow the user to filter the result set generated to include e.g., only those third-parties that were engaged in offerings in which they were underwriters.

While the above-described system is said to include a database, this is for illustrative purpose only. As is known in the art, other configurations are possible and any data structure may be used. For example, as opposed to a record-based database, table-based data files may be employed.

While the above-described system is said to include an electronic database, this is for illustrative purposes only and other non-electronic configurations are possible. For example, instead of the pool of qualified service providers being published in an electronic form, a printed publication may be produced by third-party facilitator 42 on a periodic basis (e.g., weekly or monthly, for example). This publication would allow potential customers to review the qualifications of the individual service providers who are members of organization 44. Typically, such a publication would include a resource index that allows the potential customers to search the publication for qualified service providers. As above, the customer may be required to enter into a membership contract with the third-party facilitator 42 in order to review the publication. Further, the service provider would typically be required to enter into a membership agreement with third-party facilitator 42 in order to be listed within the publication. Alternatively, all potential services providers may be listed within the publication (regardless of whether they entered into a membership agreement with third-party facilitator 42). However, prior to performing a service for a customer, the service provider would be required to enter into a membership agreement with third-party facilitator 42.

While performance indicator field 160 is defined above as including numerical descriptors associated with the “buy”, “sell” and “hold” ratings issued by the service provider, other configurations are possible, such as: the addition of e.g., “strong buy” and “strong sell” ratings; numerical descriptors associated with an outperform recommendation, a market perform recommendation, and an under-perform recommendation; or the consolidation of the numeric descriptors, in which a single descriptor is used to define cross-spectrum (i.e., buy, sell and hold) rating accuracy.

While the system is described above as requiring a customer to become a member of organization 44 (i.e., enter into a contract with third-party facilitator 42) prior to being able to search database 52, this is for illustrative purpose only and other configurations are possible. For example, the customer may be allowed to search database 52 and review the qualifications of the individual service providers (e.g., service providers 18, 20, 22) prior to entering into a contract with third-party facilitator. However, prior to the performance of any services by the service provider, the customer may be required to become a member of organization 44.

Membership in organization 44 and entering into a contract with third-party facilitator 42 (for both customers and service providers) may be mutually exclusive. For example, a customer may be required to enter into a membership contract with third-party facilitator 42 prior to being able to review database 52, and may be required to enter into a service contract prior to being able to receive services from a service provider. Further, a service provider may be required to enter into a membership contract with third-party facilitator 42 prior to being listed within database 52, and may be required to enter into a service contract prior to being able to perform services for a customer.

While the performance statistics are described above as being statistical averages (e.g., an unacceptable range of 0.000-0.499 and an acceptable range of 0.500-1.000) that are associated with the “buy”, “sell” and “hold” ratings issued by the service provider over a defined period of time, this is for illustrative purposes only and other configurations are possible. For example, the performance statistics may be letter-based grades (e.g., “A”, “B”, “C”, “D” or “E”) that essentially mimic the grade school reporting system. Alternatively, the performance statistics may be based on a common scenario that is applied to all service providers that are being rated. An example (concerning securities analysis service providers) may be the determination of what the current market value for a $10,000 investment would be if: (a) the investment was made a defined period of time ago (e.g., one year, five years, or ten years, for example); and (b) the investor had followed all of the service provider's buy/sell/hold recommendations.

The performance statistic made be calculated for: (a) an individual stock; (b) the securities analyst's complete universe of stocks, equally weighted; or (c) one or more industry subsets of the securities analyst's universe of stocks, in that the various industries researched by the securities analyst are parsed so that the securities analyst's performance within specific industries/sectors may be may be compared/contrasted.

Ranking Research Providers:

As discussed above, equity research is a primary tool relied upon by investors and investment professionals to identify, evaluate and filter public companies as candidates for investment. The procurement of equity research for an offering of a security (e.g., an initial offering and/or a subsequent offering) may be an important element for the success of the offering, both during the offering and after the offering has completed. Further, once invested, equity research may be relied upon to monitor ongoing performance of a company's securities and its potential for future performance. As discussed above, equity research allows investors to make investment decisions based upon evaluations concerning the future performance potential of a security.

As would be expected, the investing public only benefits when the research performed is accurate and unbiased. Accordingly, when choosing a research provider to provide equity research concerning a security, the entity in charge of selecting the research provider (e.g., the issuer of the security, an agent of the issuer of the security, or a third-party, for example) may consider various factors, such as e.g., the research provider's experiences within a specific security sector. For example, if the desired research is going to concern securities issued by XYZ Corp (a biotechnology company) having a market capitalization of $500 million (i.e., a small cap security), it may be desirable to select a research provider having a high level of experience and proficiency in preparing equity research for small cap biotechnology securities. Accordingly, service management system 10 may be configured to allow a user to rank two or more research providers and/or rate a specific research provider based upon various user-defined ranking/rating criteria.

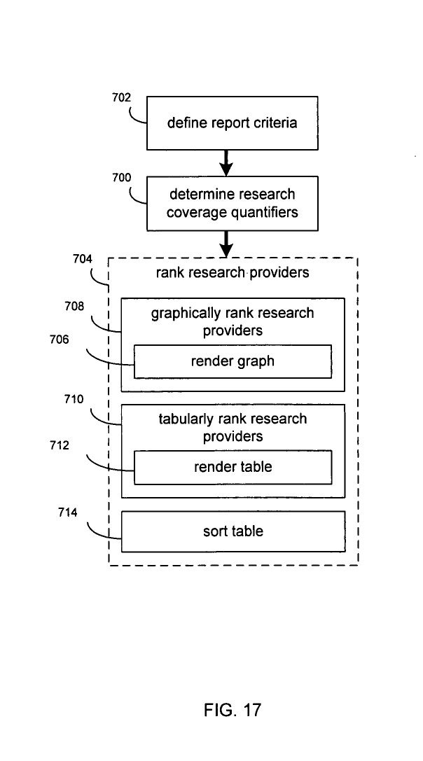

Referring also to FIG. 17, service management system 10 may determine 700 one or more research coverage quantifiers for each of a plurality of research providers that provide equity research within a specific securities sector (i.e., an area of interest or concentration, such as a technological area and/or a market capitalization range). Information concerning the plurality of research providers may be maintained on database 52 (FIG. 2). One or more of the research coverage quantifiers may be indicative, at least in part, of the specialization of the research provider within the specified securities sector. For example, since XYZ Corp is a biotechnology company, it may be desirable to select a research provider that has experience providing research for biotechnology companies. Further, since XYZ Corp is a small cap company, it may be desirable to select a research provider that has experience providing research for small cap companies.

All or a portion of the data used by service management system 10 to generate e.g., the various research coverage quantifiers may be obtained from a third party (e.g., third party 49, FIG. 1), examples of which include (but are not limited to) Nelson's Thomson One Analytics™, First Call™, Reuters™, and Multex™. Alternatively, the data used by service management system 10 may be compiled by third-party facilitator 42.

Examples of the various research coverage quantifiers may include a “focus” research coverage quantifier and a “commitment” research coverage quantifier. Further, each research coverage quantifier may be based on various criteria and may be calculated in numerous ways.

For example, the “focus” research coverage quantifier and the “commitment” research coverage quantifier may be based on:
the number of research providers that fit a specified criteria (i.e., for the “commitment” research coverage quantifier) or the number of research providers that fit the specified criteria divided by the total number of research providers (i.e., for the “focus” research coverage quantifier). Investment banking, the marketing of stocks, and the trading of stocks may depend (to varying degrees) upon the number of the research providers, as the research providers are the source of the raw product knowledge that drives most of these businesses. Accordingly, if the entity selecting the research provider knows e.g., how many research providers within a firm are dedicated to a specific sector (e.g., biotechnology), the entity making the selection can gauge the relative importance of that specific sector to that research firm and the likely relevance of that research firm to institutional investors.
the number of companies covered by the research firm that fit a specified criteria (i.e., for the “commitment” research coverage quantifier) or the number of companies that fit the specified criteria divided by the total number of companies (i.e., for the “focus” research coverage quantifier). Companies may be categorized by size and industry and this, in turn, may be correlated to e.g., the types of investors (small cap v. large cap) and the types of companies (e.g. small cap biotech) that the firm is likely to focus on.
the number of research reports generated by the research provider (over a defined time frame) that fit a specified criteria (i.e., for the “commitment” research coverage quantifier) or the number of research reports generated by the research provider (over a defined time frame) that fit the specified criteria divided by the total number of research reports generated by the research provider during the same defined time frame (i.e., for the “focus” research coverage quantifier). This may allow the entity selecting the research provider to define the breadth (i.e., frequency) of research coverage by a particular research provider.
the number of pages of research generated by the research provider (over a defined time frame) that fit a specified criteria (i.e., for the “commitment” research coverage quantifier) or the number of pages of research generated by the research provider (over a defined time frame) that fit the specified criteria divided by the total number of pages of research generated by the research provider during the same defined time frame (i.e., for the “focus” research coverage quantifier). This may help define the depth of research coverage, in that if a first research provider is writing fewer pages of research fitting the specified criteria than a second research provider, it is indicative of the first research provider being less immersed (within the specified criteria) than the second research provider.
the number of rating changes issued by the research provider (over a defined time frame) that fit a specified criteria (i.e., for the “commitment” research coverage quantifier) or the number of rating changes issued by the research provider (over a defined time frame) that fit the specified criteria divided by the total number of rating changes issued by the research provider during the same defined time frame (i.e., for the “focus” research coverage quantifier). This may help define the type and depth of research coverage. For example, fast relative changes in ratings within an industry may be a sign that the research provider has a high trading orientation; while slow relative changes in ratings within an industry may be an indication that the research provider has more of a long-term investor orientation.

Continuing with the above-stated example, if customer 12 desired to obtain research concerning securities issued by XYZ Corp (a biotechnology company) having a market capitalization of $500 million (i.e., a small cap security), it may be desirable for customer 12 to select a research provider having a high level of experience and proficiency in preparing equity research for small cap biotechnology securities. As discussed above, customer 12 may be the issuer of the security, an agent of the issuer of the security, or a third-party, for example.

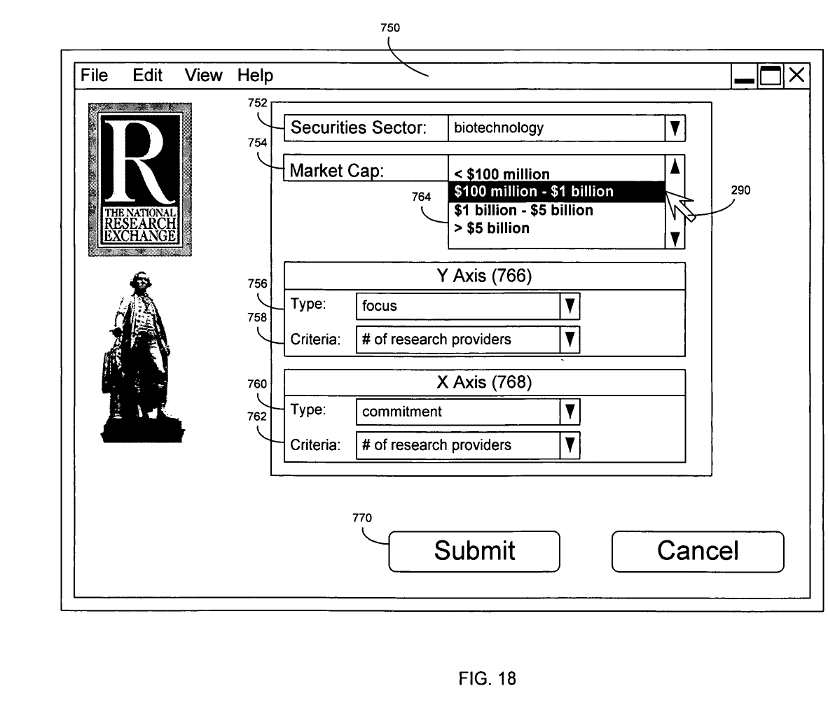

Referring also to FIG. 18, customer 12 may use report selection screen 750 to define 702 report criteria using screen pointer 290 that is controllable by a pointing device such as a computer mouse, not shown. Report selection screen 750 may include a plurality of fields 752, 754, 756, 758, 760, 762 that allow customer 12 to define the type of report that they wish to generate. For example, a “Securities Sector” field 752 may allow customer 12 to define the securities sector, such as: the health care sector; the business sector; the consumer sector; the medical sector; the energy sector; the insurance sector; the contracting sector; the transportation sector; the pharmaceutical sector; the environmental sector; the technology sector; the telecom sector; the financial sector; the academic sector; the entertainment sector; and the biotechnology sector.

A “Market Cap” field may allow customer 12 to define the market capitalization range for the report to be generated. For example, via screen pointer 290, customer 12 may use drop down menu 764 to select one of e.g., “<$100 million” (i.e., a micro cap range), “$100 million-$1 billion” (i.e., a small cap range), $1 billion-$5 billion” (i.e., a mid cap range) and “>$5 billion” (i.e., a large cap range).

A “Y Axis” portion 766 of report selection screen 750 may allow customer 12 to define the data type (via field 756) and the data criteria (via field 758) for the Y axis (i.e., the vertical axis).

Via field 756, customer 12 may define the type of research coverage quantifier (e.g., focus or commitment) to be associated with the Y axis. As discussed above, “focus” defines the percentage of a data set that is applied to a specific area and “commitment” defines the raw number applied to a specific area. For example, if the specific area is biotechnology and a research firm had a total of 10,000 research providers, 1,000 of which generate research in the biotechnology sector, the “commitment” of the research firm to the biotechnology securities sector is 1,000 and the “focus” of the of the research firm on the biotechnologies securities sector is 10.00% (i.e., 1,000/10,000).

As discussed above, “focus” and “commitment” may be determined in one of a plurality of manners e.g., number of research providers that fit a specified criteria, number of companies covered by the research firm that fit a specified criteria, number of research reports generated by the research provider that fit a specified criteria, number of pages of research generated by the research provider that fit a specified criteria, and/or the number of rating changes issued by the research provider that fit a specified criteria. Accordingly, field 758 may allow customer 12 to define the manner in which the “focus” or “commitment” (as define by field 756) is defined. Accordingly, field 758 may allow customer 12 to select e.g., “# of research providers”, “# of companies”, “# of research reports”, “# of pages of research”, or “# of rating changes issued”.

An “X Axis” portion 768 of report selection screen 750 may allow customer 12 to define the data type (via field 760) and the data criteria (via field 762) for the X axis (i.e., the horizontal axis).

Via field 760, customer 12 may define the type of research coverage quantifier (e.g., “focus” or “commitment”) to be associated with the X axis. Field 762 may allow customer 12 to define the manner in which the “focus” or “commitment” (as define by field 760) is defined. Accordingly, field 762 may allow customer 12 to select e.g., “# of research providers”, “# of companies”, “# of research reports”, “# of pages of research”, or “# of rating changes issued”.

Once customer 12 defines fields 752, 754, 756, 758, 760, 762 (or a portion thereof), customer 12 may select the submit button 770 (via screen pointer 290) and determine 700, for each of the plurality for research providers, the one or more research coverage quantifiers. As discussed above, all or a portion of the data used by service management system 10 to generate e.g., the various research coverage quantifiers may be obtained from a third party (e.g., third party 49, FIG. 1), examples of which include (but are not limited to) Nelson's Thomson One Analytics™, First Call™, Reuters™, and Multex™. Alternatively, the data may be compiled by third-party facilitator 42.

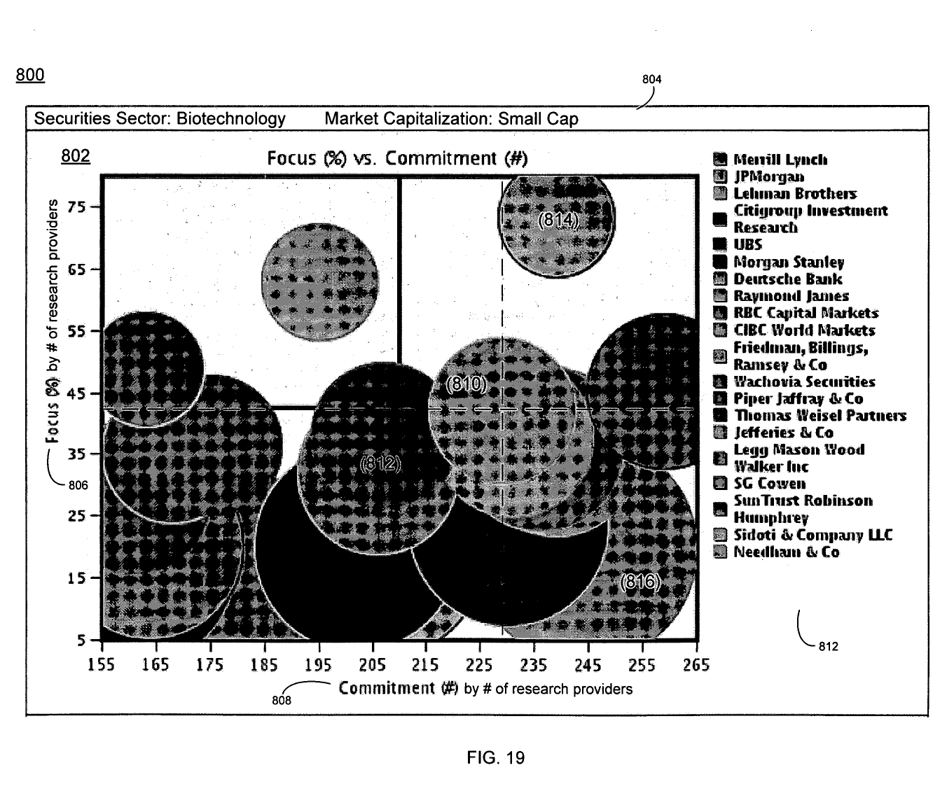

Referring also to FIG. 19 and continuing with the above-stated example, upon customer 12 selecting submit button 770, the various research coverage quantifiers may be determined 700 and customer 12 may be presented with a report 800 that ranks 704 each of the plurality of research providers. In this particular example, report 800 is shown to include a two-dimensional graph 802 (which is rendered 706 by service management system 10) that graphically ranks 708 each of the plurality of research providers based, at least in part, upon at least one of the research coverage quantifiers.

Graph 802 may include a criteria field 804 for defining the criteria used when generating graph 802. In this example, criteria field 804 may define the “Securities Sector” as “Biotechnology” and the “Market Capitalization” as “Small Cap”. A Y-axis label 806 may define the type (i.e., “focus”) and the criteria (i.e., “# of research providers”) defined in fields 756, 758 of report selection screen 750. An X-axis label 808 may define the type (i.e., “commitment”) and the criteria (i.e., “# of research providers”) defined in fields 760, 762 of report selection screen 750.

While, in this particular example, two-dimensional graph 802 is shown to be a bubble chart, other configurations are possible. For example, report 800 may include a standard two-dimensional X-Y Cartesian graph (not shown) in which each data point is shown as an identically-sized data point.

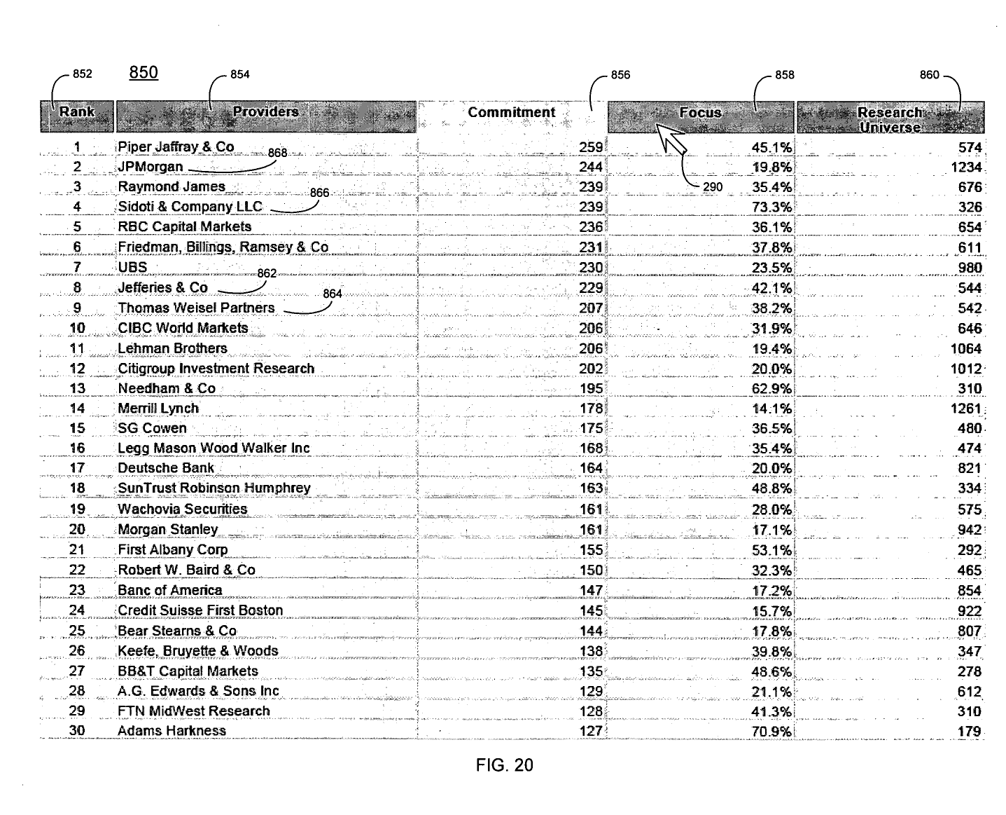

Referring also to FIG. 20, report 800 may include a data table 850 that tabularly itemizes the data graphically displayed in two-dimensional graph 802, resulting in each of the plurality of research providers being tabularly ranked 710 based, at least in part, upon at least one of the research coverage quantifiers determined 700 by service management system 10. Table 850 (which is rendered 712 by service management system 10) may include a plurality of columns 852, 854, 856, 858, 860 for itemizing the data (e.g., research coverage quantifiers) associated with each of the ranked research providers. For example, column 852 defines the rank associated with each research provider and column 854 defines the name of each research provider. In this particular example, column 856 defines the “Commitment” research coverage quantifier associated with each research provider and column 858 defines the “Focus” research coverage quantifier associated with each research provider. Additionally, in this example, column 860 defines the “Research Universe” research coverage quantifier associated with each research provider.

Typically, each line item within data table 850 corresponds with a data point on graph 802. For example, data point 810 (FIG. 19) corresponds to line item 862 (FIG. 20). Accordingly, data point 810 defines a data point having a “Focus” research coverage quantifier of 42.1% (as illustrated in column 858 of table 850) and a “Commitment” research coverage quantifier of 229 (as illustrated in column 856 of table 850). While table 850 is shown being sorted 714 based upon the “Commitment” research coverage quantifier, customer 12 may sort 714 table 850 based upon the other columns within table 850. For example, if customer 12 wanted to sort 714 table 850 based upon the “Focus” research coverage quantifier, customer 12 may e.g., sort 714 by “Focus” by “clicking” on the heading of “Focus” column 858 using screen pointer 290. Additionally/alternatively, table 850 may be sorted 714 based upon: the name of the research provider (i.e., by clicking on “Providers” column 854); or the research universe research coverage quantifier (i.e., by clicking on “Research Universe” 860).

As is known in the art, a bubble chart may allow a two-dimensional graph (e.g., graph 802) to display three-dimensional data. For example, the size (i.e., diameter) of the individual bubbles within graph 802 may be indicative of the “Research Universe” of the research provider. For example and as shown in FIG. 19, data point 810 corresponds to a line item (i.e., line item 862) having a “Research Universe” of 544. As data point 812 corresponds to a line item (i.e., line item 864) having a “Research Universe” of 542, data point 812 is approximately the same size as data point 810. However, as data point 814 corresponds to a line item (i.e., line item 866) having a “Research Universe” of 326, data point 814 is noticeably smaller in size than data point 810. Conversely, as data point 816 corresponds to a line item (i.e., line item 868) having a “Research Universe” of 1234, data point 814 is noticeably larger in size than data point 810.

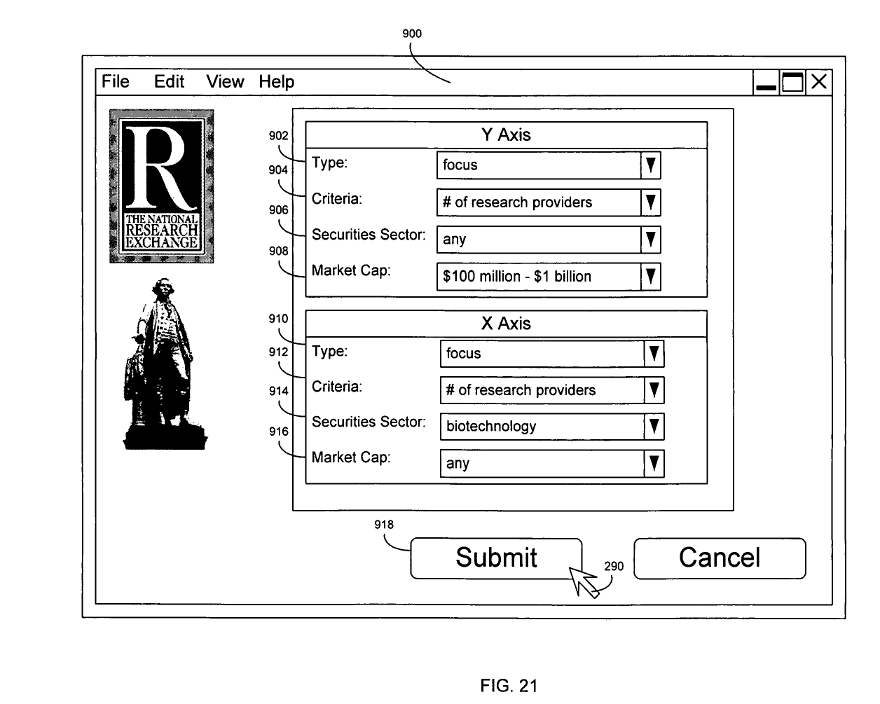

While graph 802 is discussed above as having both its X-axis and Y-axis based upon a “Market Cap” of “$100 million-$1 billion” and a “Securities Sector” equal to “biotechnology”, other configurations are possible. For example and referring also to FIGS. 21 & 22, report selection screen 900 may allow a customer to define a unique “Market Cap” and/or “Securities Sector” for each axis. Accordingly, for the Y Axis, user 12 may define: the “Type” (via field 902); the “Criteria” (via field 904); the “Securities Sector” (via field 906); and the “Market Cap” (via field 908). Further, for the X Axis, user 12 may define: the “Type” (via field 910); the “Criteria” (via field 912); the “Securities Sector” (via field 914); and the “Market Cap” (via field 916).

Once customer 12 defines fields 902, 904, 906, 908, 910, 912, 914, 916 (or a portion thereof), customer 12 may select the submit button 918 (via screen pointer 290) to generate report 950 that ranks research providers in accordance with the criteria defined within report selection screen 900. In this particular example, report 950 is shown to include a two-dimensional graph 952 for graphically ranking the various research providers included within graph 952. Graph 952 may include a criteria field 954 for defining the criteria used when generating graph 952. In this example, criteria field 954 defines the “Securities Sector” as “Any” and the “Market Capitalization” as “$100 million-$1 billion” for the “Y-Axis”. Criteria field 954 may also define the “Securities Sector” as “Biotechnology” and the “Market Capitalization” as “Any” for the “X-Axis”. A Y-axis label 956 may define the type (i.e., “Size Focus”) and the criteria (i.e., “# of research providers”) defined in fields 902, 904 of report selection screen 900. An X-axis label 958 may define the type (i.e., “Industry Focus”) and the criteria (i.e., “# of research providers”) defined in fields 910, 912 of report selection screen 900.

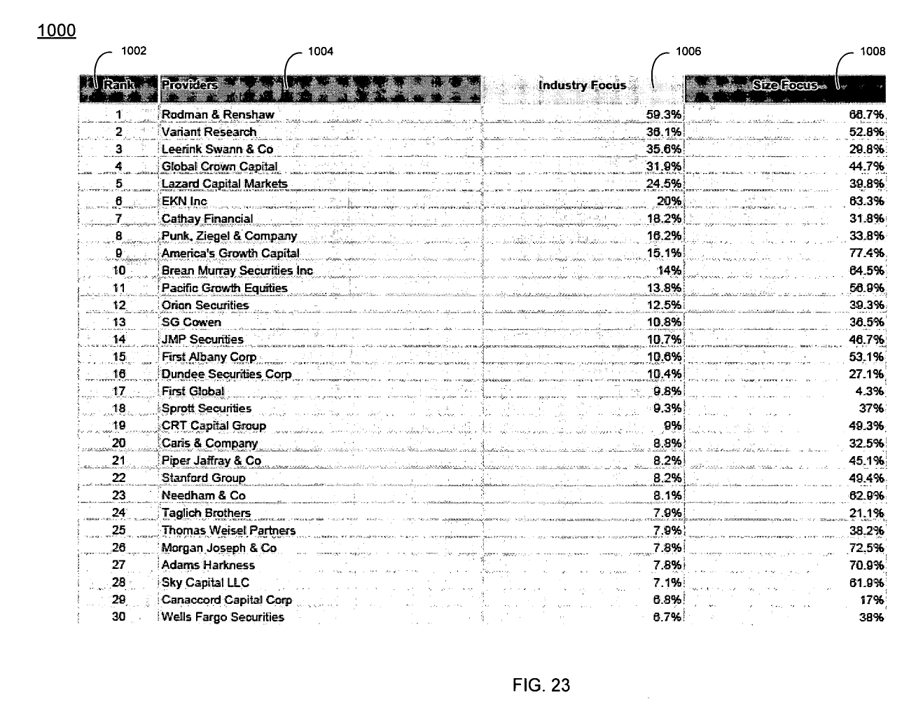

Referring also to FIG. 23, report 950 may include a data table 1000 that tabularly itemizes the data graphically displayed in two-dimensional graph 952. Table 1000 may include a plurality of columns 1002, 1004, 1006, 1008 for itemizing the data associated with each of the ranked research providers. In this particular example, column 1006 defines the “Industry Focus” associated with each research provider and column 1008 defines the “Size Focus” associated with each research provider.

While graphs 802, 952 are discussed above as being two-dimensional graphs, other configurations are possible. For example, graphs 802, 952 may be rendered as three-dimensional graphs in which e.g., the third-dimension (i.e., along a Z-axis) represents e.g., the research universe (as defined in column 860 of table 850).

While the system is described above as generating a graph and/or a table that defines research coverage quantifiers for a plurality of research providers, other configurations are possible. For example, a graph/table may be generated that defines research coverage quantifiers for only a single research provider.

While the system is described above as requiring members of organization 44 to report alleged violations of the code of conduct through a secure website, this is for illustrative purposes only and other configurations are possible. For example, system 10 may be configured so that allegation are reported in writing or telephonically to third-party facilitator 42.

While the system is described above as requiring members of organization 44 to report alleged violations of the code of conduct, this is for illustrative purposes only and other configurations are possible. For example, system 10 may be configured so that the reporting process is voluntary.

While the market capitalization breakdown is described above as being a graphical bar chart, this is for illustrative purposes only and other configurations are possible. For example, a graphical pie chart or a text-based table may be displayed.

A number of implementations have been described. Nevertheless, it will be understood that various modifications may be made. Accordingly, other implementations are within the scope of the following claims.

What is claimed is:

1. A method of rating a research provider comprising:
determining, for each of a plurality of research providers that provide equity research within a securities sector, one or more research coverage quantifiers, wherein at least one of the research coverage quantifiers is indicative, at least in part, of the specialization of the research provider within the securities sector; and
ranking each of the plurality of research providers based, at least in part, upon at least one of the research coverage quantifiers.

2. The method of claim 1 wherein ranking each of the plurality of research providers includes:
graphically ranking each of the plurality of research providers based, at least in part, upon at least one of the research coverage quantifiers.

3. The method of claim 2 wherein the one or more research coverage quantifiers includes a first research coverage quantifier and a second research coverage quantifier, and graphically ranking each of the plurality of research providers includes:
rendering a two-dimensional graph that includes a first axis corresponding to the first research coverage quantifier and a second axis corresponding to the second research coverage quantifier.

4. The method of claim 3 wherein the one or more research coverage quantifiers includes a third research coverage quantifier, and wherein rendering a two-dimensional graph includes:
rendering a bubble chart that includes a first axis corresponding to the first research coverage quantifier, a second axis corresponding to the second research coverage quantifier, and a plurality of graphical indicia indicative of the third research coverage quantifier.

5. The method of claim 2 wherein the one or more research coverage quantifiers includes a first research coverage quantifier, a second research coverage quantifier, and a third research coverage quantifier, and graphically ranking each of the plurality of research providers includes:
rendering a three-dimensional graph that includes a first axis corresponding to the first research coverage quantifier, a second axis corresponding to the second research coverage quantifier, and a third axis corresponding to the third research coverage quantifier.

6. The method of claim 1 wherein ranking each of the plurality of research providers includes:
tabularly ranking each of the plurality of research providers based, at least in part, upon at least one of the research coverage quantifiers.

7. The method of claim 6 wherein tabularly ranking each of the plurality of research providers includes:
rendering a multi-column table that includes a first column corresponding to at least one of the research coverage quantifiers.

8. The method of claim 6 wherein the one or more research coverage quantifiers includes a first research coverage quantifier and a second research coverage quantifier, and tabularly ranking each of the plurality of research providers includes:
rendering a multi-column table that includes a first column corresponding to the first research coverage quantifier and a second column corresponding to the second research coverage quantifier.

9. The method of claim 8 further comprising:
allowing a user to sort the multi-column table based, at least in part, on one of the first and second research coverage quantifiers.

10. The method of claim 1 wherein the securities sector is chosen from the group consisting of: a health care sector; a business sector; a consumer sector; a medical sector; an energy sector; an insurance sector; a contracting sector; a transportation sector; a pharmaceutical sector; an environmental sector; a technology sector; a telecom sector; a financial sector; an academic sector; an entertainment sector; and a the biotechnology sector.

11. The method of claim 1 wherein the securities sector is chosen from the group consisting of: a micro cap securities sector; a small cap securities sector; a mid cap securities sector; and a large cap securities sector.

12. The method of claim 1 wherein the one or more research coverage quantifiers includes a commitment quantifier.

13. The method of claim 1 wherein the one or more research coverage quantifiers includes a focus quantifier.

14. A server computer configured to perform the method of claim 1.

15. A computer program product residing on a computer readable medium having a plurality of instructions stored thereon which, when executed by the processor, cause that processor to perform operations comprising:
determining, for each of a plurality of research providers that provide equity research within a securities sector, one or more research coverage quantifiers, wherein at least one of the research coverage quantifiers is indicative, at least in part, of the specialization of the research provider within the securities sector; and
ranking each of the plurality of research providers based, at least in part, upon at least one of the research coverage quantifiers.

16. The computer program product of claim 15 wherein the instructions for ranking each of the plurality of research providers include instructions for:
graphically ranking each of the plurality of research providers based, at least in part, upon at least one of the research coverage quantifiers.

17. The computer program product of claim 16 wherein the one or more research coverage quantifiers includes a first research coverage quantifier and a second research coverage quantifier, and the instructions for graphically ranking each of the plurality of research providers include instructions for:
rendering a two-dimensional graph that includes a first axis corresponding to the first research coverage quantifier and a second axis corresponding to the second research coverage quantifier.

18. The computer program product of claim 17 wherein the one or more research coverage quantifiers includes a third research coverage quantifier, and wherein the instructions for rendering a two-dimensional graph include instructions for:
rendering a bubble chart that includes a first axis corresponding to the first research coverage quantifier, a second axis corresponding to the second research coverage quantifier, and a plurality of graphical indicia indicative of the third research coverage quantifier.

19. The computer program product of claim 16 wherein the one or more research coverage quantifiers includes a first research coverage quantifier, a second research coverage quantifier, and a third research coverage quantifier, and the instructions for graphically ranking each of the plurality of research providers include instructions for:
rendering a three-dimensional graph that includes a first axis corresponding to the first research coverage quantifier, a second axis corresponding to the second research coverage quantifier, and a third axis corresponding to the third research coverage quantifier.

20. The computer program product of claim 15 wherein the instructions for ranking each of the plurality of research providers include instructions for:
tabularly ranking each of the plurality of research providers based, at least in part, upon at least one of the research coverage quantifiers.

21. The computer program product of claim 20 wherein the instructions for tabularly ranking each of the plurality of research providers include instructions for:
rendering a multi-column table that includes a first column corresponding to at least one of the research coverage quantifiers.

22. The computer program product of claim 20 wherein the one or more research coverage quantifiers includes a first research coverage quantifier and a second research coverage quantifier, and the instructions for tabularly ranking each of the plurality of research providers include instructions for:
rendering a multi-column table that includes a first column corresponding to the first research coverage quantifier and a second column corresponding to the second research coverage quantifier.

23. The computer program product of claim 22 further comprising instructions for:
allowing a user to sort the multi-column table based, at least in part, on one of the first and second research coverage quantifiers.

24. The computer program product of claim 15 wherein the securities sector is chosen from the group consisting of: a health care sector; a business sector; a consumer sector; a medical sector; an energy sector; an insurance sector; a contracting sector; a transportation sector; a pharmaceutical sector; an environmental sector; a technology sector; a telecom sector; a financial sector; an academic sector; an entertainment sector; and a the biotechnology sector.

25. The computer program product of claim 15 wherein the securities sector is chosen from the group consisting of: a micro cap securities sector; a small cap securities sector; a mid cap securities sector; and a large cap securities sector.

26. The computer program product of claim 15 wherein the one or more research coverage quantifiers includes a commitment quantifier.

27. The computer program product of claim 15 wherein the one or more research coverage quantifiers includes a focus quantifier.
